(19) United States
(12) Patent Application Publication
(10) Pub. No.: US 2015/0142543 A1
(43) Pub. Date: May 21, 2015

(54) SMART SOURCE DIRECT COUPON DELIVERY AND PROCESSING

(71) Applicant: News America Marketing Properties, LLC, New York, NY (US)

(72) Inventor: Henri LELLOUCHE, Fairfield, CT (US)

(73) Assignee: News America Marketing Properties, LLC, New York, NY (US)

(21) Appl. No.: 14/084,271

(22) Filed: Nov. 19, 2013

(51) Int. Cl. G06Q 30/02

(52) U.S. Cl. CPC G06Q 30/0222
USPC 705/14.23

(57) ABSTRACT

A method, system and program product for communicating with a plurality of customer devices and a plurality of etailers, the method comprising receiving selection of an etailers from a customer device for an online shopping cart process; receiving a captured image of a coupon for a product; creating an electronic coupon for the product; feeding, data on products and/or services of the selected etailer; computing a monetary total for the selected etailer for the products; serving the monetary total for the selected etailer and the monetary totals computed for the other etailers; sending electronic communication to one of the etailers to deliver the products; initiating transfer of funds to the one etailer; serving upon initiation of a loyalty card association process, a list of loyalty cards of retailers to a customer device; receiving a selection; associating the electronic coupon to the loyalty card for the selected retailer.

### FIELD OF THE INVENTION

Various embodiments relate generally to the field of promotional content redemption. More particularly, various embodiments relate to promotional content redemption, e.g., redeeming free standing inserts (FSI), using various electronic devices to create an interactive, electronic coupon customer experience.

### BACKGROUND OF THE INVENTION

Traditional marketing approaches have included the use of promotional content in the form of, e.g., advertisements and/or discount offers distributed to customers in the form of paper or printed discount certificates commonly referred to as coupons or free standing inserts (FSI). Coupons are generally distributed via, e.g., mailers or newspaper cutouts, or presented to customers at a retail location. These paper inserts typically contain transactional data describing a particular transaction enabled by the coupon, such as a product's description, the coupon's amount or value, an expiration date, etc. Additionally, such coupons may contain certain identification data, e.g., various numbers, letters, barcodes or other symbols sufficient to uniquely identify the coupon and/or the product or service to be discounted. For example, upon presentation of a coupon at a point-of-sale terminal, the coupon could be scanned or otherwise identified and the requisite discount or value of the coupon could be applied to a purchased product.

It is important to improve and facilitate the FSI redemption process for customers.

### SUMMARY OF THE INVENTION

Various embodiments are directed a system comprising: a system communication component configured to communicate electronically over one or more networks with a plurality of customer devices and with a plurality of etailers; a memory configured to store for each of the plurality of customers: customer address data; at least one payment account number; a server configured in one or more computers for an online shopping cart process: to receive, by the one or more computers via a network communications component, a selection of one from a plurality of etailers from a first one of the customer devices for the online shopping cart process for a first customer; to receive, by the one or more computers via the network communications component, a captured image or scan of a coupon for a product or service; to identify the image or scan, by the one or more computers, and determine a company issuer of the coupon; access data associated with the company issuer for electronic coupon creation; identify a product and/or service to which the coupon applies that is offered by the selected etailer; to create, by the one or more computers, an electronic coupon for the product or service based at least in part on the data for the electronic coupon; to feed, by the one or more computers via the network communications component, data on the product and/or service of the selected etailer including data on a price of the product and/or service with the coupon applied, and to feed other products and/or services of the etailer, to the first customer device; the server configured to receive, by the one or more computers, a selection of one or more of the products and/or services of the selected etailer in the online shopping cart process; the server configured to automatically compute, by the one or more computers, a monetary total for the selected etailer for the one or more products and/or services selected in the online shopping cart process including to automatically apply a discount for the coupon; the server configured, by the one or more computers, to automatically obtain one or more other of the etailers that sell the one or more products and/or services listed in the shopping cart and to compute a respective monetary total for each of these one or more other etailers for the one or more products and/or services selected in the online shopping cart process, with the created electronic coupon applied; the server configured, by the one or more computers via the network communications component, to serve for display the monetary total for the selected etailer and the respective one or more monetary totals computed for the one or more other etailers, with a facility to switch etailers; the server configured, by the one or more computers via the network communications component, to send an electronic communication to one of the etailers to deliver the one or more products and/or services to the first customer, upon receiving a purchase request for the one etailer; the server configured, by the one or more computers, to cancel an the online shopping cart process, upon receiving a cancellation request; and the server configured to initiate transfer of funds to the one etailer when the purchase request has been received.

In embodiments, the system server operation to create an electronic coupon may be configured to include code data from the company issuer in the electronic coupon.

In embodiments, the server operation to obtain one or more other of the etailers that sell the products or services listed in the shopping cart may comprise for each of multiple of the respective other etailers, searching the products and/or services offered by the respective other etailer to determine if all of the one or more products and/or services in the online shopping cart process match products and/or services offered by the respective etailer.

In embodiments, there may be a plurality of products and/or services selected in the online shopping cart, and wherein the computing steps for the monetary totals may comprise for each of the selected etailer and the one or more other etailers, adding together respective prices for the respective products and/or services selected to obtain the monetary total.

In embodiments, the server may be configured with program code to transfer or initiate transfer of funds for the online shopping purchase in real time.

In embodiments, the server may be configured to accumulate purchased products over a period of time for a given one of the etailers and to send the products accumulated to the given etailer in a batch transfer, and the server may be configured to initiate the transfer of funds from a plurality of the accounts associated with the customer devices or their owners to the given one of the etailers at a time of the batch transfer.

In embodiments, the server may be configured to serve, by the one or more computers via the communications component, one or more of the plurality of etailers to the first customer device based at least in part on the products and/or services identified for the coupon, upon initiation of the online shopping cart process.

In embodiments, the memory may be configured to store for each of the plurality of customers, loyalty card data and associated coupons for each of a plurality of retailer loyalty cards associated with the customer, and the server may be configured, by the one or more computers to: to serve, by the one or more computers, upon initiation of a loyalty card association process, a list of a plurality of loyalty cards of retailers to a second one of the customer devices; to receive, by the one or more computers via the network communications component, a selection of one of the plurality of the loyalty cards from the second customer device; to receive by the system communications component a captured image or scan of a coupon for a product or service from the second customer device; to identify the image or scan of the coupon and determine, by the one or more computers, data associated with a company issuer of the coupon for creating an electronic coupon; to create, by the one or more computers, an electronic coupon for the product or service based at least in part on the data for creating the electronic coupon; and to electronically associate in the memory, by the one or more computers, upon receipt of the selection of the loyalty card of one of the retailers, the electronic coupon to the loyalty card of the second customer for the selected retailer.

In embodiments, the server may be further configured in the one or more computers to determine if the etailer selected can fulfill the product or service of the coupon captured image or scan, when the etailer is selected for association of its loyalty card to the coupon; and the server may be further configured in the one or more computers to serve a message that the etailer selected does not fulfill the product or service of the coupon captured image or scan, when that is true.

In embodiments, a method for communicating with a plurality of customer devices and a plurality of etailers, may comprise: receiving, by one or more computers via a network communications component, a selection of one from a plurality of the etailers from a first one of the customer devices for an online shopping cart process; receiving, by the one or more computers via the network communications component, a captured image or scan of a coupon for a product or service; identifying the captured image or scan of the coupon, by the one or more computers, and determining, by the one or more computers, a company issuer of the coupon; accessing, by the one or more computers, data associated with the company issuer for electronic coupon creation; identifying, by the one or more computers, a product and/or service to which the coupon applies that is offered by the selected etailer; creating, by the one or more computers, an electronic coupon for the product or service based at least in part on the data for the electronic coupon; feeding, by the one or more computers via the network communications component, data on the product and/or service of the selected etailer including data on a price of the product and/or service with the created electronic coupon applied, and data on other products and/or services of the etailer, to the first customer device; receiving, by the one or more computers via the network communications component, a selection of one or more of the products and/or services of the selected etailer for an online shopping cart in the online shopping cart process; automatically computing, by the one or more computers, a monetary total for the selected etailer for the one or more products and/or services selected in the online shopping cart including automatically applying a discount for the coupon; automatically obtaining, by the one or more computers, one or more other of the etailers that sell the one or more products and/or services listed in the online shopping cart and computing a respective monetary total for each of these one or more other etailers for the one or more products and/or services selected in the online shopping cart, with the created electronic coupon applied; serving for display, by the one or more computers via the network communications component, the monetary total for the selected etailer and the respective one or more monetary totals computed for the one or more other etailers, with a facility to switch etailers; sending, by the one or more computers via the network communications component, an electronic communication to one of the etailers to deliver the one or more products and/or services to the first customer, upon receiving a purchase request for the one etailer; and initiating transfer, by the one or more computers, of funds to the one etailer when the purchase request has been received.

In embodiments, the method may further comprise executing a respective contract with each of the plurality of etailers to withhold and not disclose customer identification data to the company issuer of the created electronic coupon that was applied.

In embodiments, there are a plurality of products and/or services selected in the online shopping cart, and the computing steps for the monetary totals for the selected etailer and the one or more other etailers, may comprise adding respective prices for the respective products and/or services to obtain the monetary total for the respective etailer.

In embodiments, the method may further comprise serving, by one or more computers, upon initiation of a loyalty card association process, a list of a plurality of loyalty cards of retailers to a second one of the customer devices; receiving, by the one or more computers via the network communications component, a selection of one of the plurality of the loyalty cards from the second customer device; receiving, by the system communications component, a captured image or scan of a coupon for a product or service from the second customer device; identifying the image or scan of the coupon and accessing, by the one or more computers, data associated with a company issuer of the coupon for creating an electronic coupon; creating, by the one or more computers, an electronic coupon for the product or service based at least in part on the data for the electronic coupon; and electronically associating in memory, by the one or more computers, upon receipt of the selection of the loyalty card of one of the retailers, the electronic coupon to the loyalty card of the second customer for the selected retailer.

In embodiments, for operating a customer network device of a customer that comprises: a communications component configured to communicate electronically over one or more networks; an image capture or scanner component; a graphical user interface (GUI) screen; a memory configured with one or more API's for access to a first server and a second server; a computer processor operatively connected to the image capture or scanner component, the GUI screen, and the memory, a method may comprise: a loyalty card association sub-method comprising: receiving, by the computer processor via the network communications component, a first list of a first plurality of retailers, and displaying, by a computer on a screen, the first list of the first plurality of retailers; receiving, by the computer processor via the network communications component, a selection of one of the retailers from the customer; imaging or scanning, by the image capture or scanner component, a coupon of a company issuer for a product or service to obtain a first coupon image or scan; transmitting, by the communications component, the first coupon captured image or scan to the first server with instructions to create a first electronic coupon and associate it to a loyalty card of the retailer selected; an online shopping cart sub-method, comprising: receiving, by the computer processor via the network communications component, a second list of a second plurality of etailers, for the online shopping sub-method; receiving a selection of one of the etailers from the second list from the customer; transmitting, by the network communications component, the selected etailer from the second list to the second server; obtaining, by the image capture or scanner component, a second coupon captured image or scan of a second coupon for a product or service; transmitting, by the communications component, the second coupon captured image or scan to the second server to create a second electronic coupon; receiving, via the communications component and displaying on the GUI screen, data for a product and/or service associated with the second coupon along with the respective a price with a discount of the created electronic second coupon applied, and receiving data for other products and/or services offered by the selected etailer from the second list; receiving, by the computer, a selection of one or more products and/or services from the customer for an online shopping cart process for the selected etailer of the second list; receiving, by the computer processor via the communications component, a monetary total for the selected etailer of the second list for the one or more products and/or services selected in the online shopping cart sub-method and automatically apply the discount for the second coupon; receiving, by the computer processor via the communications components and displaying on the GUI, a list of one or more other of the etailers that sell the one or more products or services listed in the shopping cart, with a respective monetary total for each of the one or more other of etailers for the one or more of the products and/or services in the online shopping cart with the discount for the created electronic second coupon applied, with a switching button or other indicator to switch etailers; switching, by the computer processor, to one of the one or more other etailers, when the switching button or other indicator is activated; displaying on the GUI screen, by the computer processor, the one or more products and/or services in the cart, when a viewing button or other indicator is activated; and sending, by the computer processor, an electronic communication to deliver the one or more products and/or services from one of the etailers to the customer and to transfer funds to the one etailer, when a purchase button or other indicator is activated.

In embodiments, a customer electronic communication device, may comprise: a communications component configured to communicate electronically over one or more networks; an image capture or scanner component; a graphical user interface (GUI) screen; a processor operatively connected to the image capture or scanner component, the GUI screen, and the memory, wherein the processor is configured with processes: an association process that uses the image capture or scanner component to image capture or scan a first coupon of a company issuer and facilitate association of the coupon with a selected loyalty card; an online shopping cart process using the image capture or scanner component to image capture or scan a second coupon and initiate online shopping via the Internet by the communications component; wherein the association process to image capture or scan and associate the coupon to a loyalty card comprises sub-processes and menus for display on the GUI screen to: display, by the processor on the GUI screen, loyalty cards of multiple retailers and a capability to receive a selection of a loyalty card of one of the retailers from a customer; activate, by the processor, the image capture or scanner component to image capture or scan a coupon for a product or service; transmit, by the communications component, the coupon image capture or scan to a server for creation of an electronic coupon and associate it to a loyalty card of the one retailer selected; and wherein the online shopping cart process of comprises sub-processes and menus for display on the GUI screen to display, by the processor on the GUI screen, multiple etailers and receive a selection of one of the etailers from the customer; activate, by the processor, the image capture or scanner component to image capture or scan a coupon for a product or service; transmit, by the communications component, the coupon captured image or scan of the coupon to the second server for creation of an electronic coupon; access via the communications component and display on the GUI screen data for a product and/or service to which the coupon applies and other products and/or service, offered by the selected etailer, and receive a selection of one or more of the products and/or services from the customer for an online shopping cart; receive, via the communications component and display on the screen: 1) a monetary total for the selected etailer for the one or more products and/or services selected in the online shopping cart with the created electronic coupon automatically applied where applicable; and 2) a respective monetary total for each of one or more other of the etailers for the one or more products and/or services selected in the online shopping cart process with the created electronic coupon automatically applied in computing the respective one or more monetary totals; generate, by the processor, a display on the screen with: a button or other indicator to switch to one of the one or more other etailers; with a button or other indicator to cancel one or more products or services from the online shopping cart process, with a button or other indicator to send an electronic communication to purchase and have delivered the one or more products and/or services from one of the etailers to the customer; and a process configured in the processor to initiate transfer of funds to the one etailer upon the button or other indicator being activated to purchase.

In embodiments, a method of the invention may comprise receiving by an etailer when an online shopping cart process is initiated, by the one or more computers via the network communications component, a coupon captured image or scan for a product or service; identifying the image or scan, by the one or more computers; determining, by the one or more computers, a company issuer of the coupon; accessing, by the one or more computers, data associated with the company issuer for electronic coupon creation; identifying, by the one or more computers, a product and/or service to which the coupon applies that is offered by the retailer; creating, by the one or more computers, an electronic coupon for the product or service based at least in part on the data for the electronic coupon; feeding, by the one or more computers via the network communications component, data on the product and/or service of the etailer associated with the coupon, including data on a price of the product and/or service with the created electronic coupon applied, and feeding data on other products and/or services of the etailer to the customer device; receiving, by the one or more computers via the network communications component, a selection of one or more of the products and/or services of the etailer for an online shopping cart in an online shopping cart process; automatically computing, by the one or more computers, a monetary total for the etailer for the one or more products and/or services selected in the online shopping cart process including automatically applying a discount for the coupon; serving for display, by the one or more computers via the network communications component, the monetary total for the etailer; initiating, by the one or more computers via the network communications component, upon receiving a purchase request, a process to deliver the one or more products and/or services to the customer; initiating transfer of funds to the etailer upon receiving the purchase request.

In embodiments, the method may further comprise receiving, by the system communications component upon initiation of a loyalty card association process to a loyalty card of the etailer, a captured image or scan of a coupon for a product or service from the second customer device; identifying the image or scan of the coupon and accessing, by the one or more computers, data associated with a company issuer of the coupon for creating an electronic coupon; creating, by the one or more computers, an electronic coupon for the product or service based at least in part on the data for the electronic coupon; and electronically associating in memory, by the one or more computers, the electronic coupon to the loyalty card of the second customer for the retailer.

In embodiments, the method may further comprise automatically obtaining, by the one or more computers, one or more other of the etailers that sell the one or more products and/or services listed in the online shopping cart and computing a respective monetary total for each of these one or more other etailers for the one or more products and/or services selected in the online shopping cart, with the created electronic coupon applied.

### BRIEF DESCRIPTION OF THE DRAWINGS

Embodiments of the present invention are described by referring to the attached drawings, in which:

FIG. 1 is an exemplary configuration of the system server of the invention in the context of customer devices and etailers and retailers.

FIG. 2 illustrates a functional architecture of embodiments of a customer device.

FIG. 3 illustrates a configuration of loyalty cards and associated electronic coupons.

FIG. 4 illustrates a functional architecture of embodiments of the server system.

FIG. 5 illustrates an application architecture for embodiments of the customer device.

FIG. 6A comprises a schematic block diagram of embodiments of server method.

FIG. 6B comprises a continuation of the schematic block diagram of FIG. 6A

FIG. 6C comprises a continuation of the schematic block diagram of FIG. 6B.

FIG. 7A comprises a schematic block diagram of embodiments of customer device method.

FIG. 7B comprises a continuation of the schematic block diagram of FIG. 7A.

FIG. 7C comprises a continuation of the schematic block diagram of FIG. 7B.

FIG. 8 illustrates is a schematic block diagram of embodiments of a server method.

FIG. 9 is a diagram of an embodiment of a screen on a customer device for selecting an API.

FIG. 10 is a diagram of an embodiment of a screen on a customer device with a list of etailers.

FIG. 11 is a diagram of an embodiment of a screen on a customer device illustrating a coupon image capture.

FIG. 12 is a diagram of an embodiment of a screen on a customer device illustrating a listing of products to which a captured coupon image is associated.

FIG. 13 is a diagram of an embodiment of a screen on a customer device illustrating a selected one of the products from FIG. 12.

FIG. 14 is a diagram of an embodiment of a screen on a customer device illustrating other products available for selection from the etailer.

FIG. 15 is a diagram of an embodiment of a screen on a customer device illustrating a product selection.

FIG. 16 is a diagram of an embodiment of a screen on a customer device illustrating a listing of the total for the products in the online shopping cart from the selected etailer, and the totals for other etailers for those products in the online shopping cart.

FIG. 17 is a diagram of an embodiment of a view cart screen on a customer device.

FIG. 18 is a diagram of an embodiment of a screen on a customer device illustrating a switching to another retailer with buttons to cancel or check out.

FIG. 19 is a diagram of an embodiment of a screen on a customer device illustrating a listing of loyalty cards for selection.

FIG. 20 is a diagram of an embodiment of a screen on a customer device illustrating a button to clip the captured image of a coupon.

FIG. 21 is a diagram of an embodiment of a screen on a customer device illustrating a search of electronic coupons to clip to loyalty cards.

FIG. 22A is a schematic block diagram of an etailer licensed operation.

FIG. 22B is a continuation of the schematic block diagram of FIG. 22A.

### DETAILED DESCRIPTION OF EMBODIMENTS

Application Ser. No. 13/191,044 filed Jul. 26, 2011, is hereby incorporated by reference in its entirety.

The following description is presented to enable a person of ordinary skill in the art to make and use the invention, and is provided in the context of particular applications and their requirements. Various modifications to the embodiments will be readily apparent to those skilled in the art, and the generic principles defined herein may be applied to other embodiments and applications without departing from the spirit and scope of the invention. In the following description, numerous details are set forth for the purpose of explanation. However, one of ordinary skill in the art will realize that the invention may be practiced without the use of these specific details. In other instances, well-known structures and devices are shown in block diagram form in order not to obscure the description of the invention with unnecessary detail. Thus, the present invention is not intended to be limited to the embodiments shown, but is to be accorded the widest scope consistent with the principles and features disclosed herein.

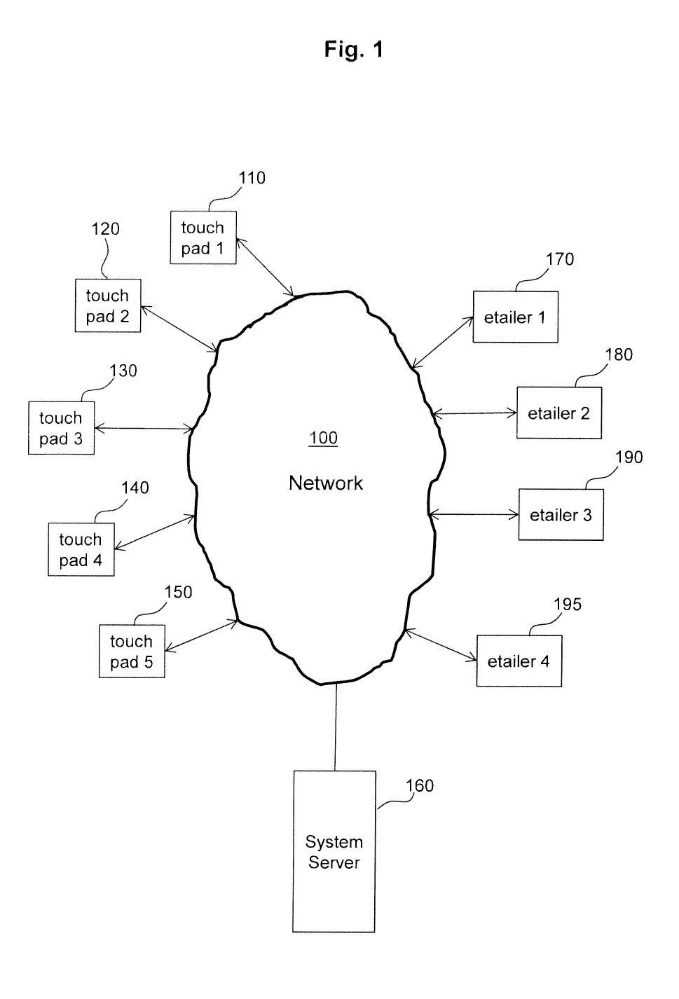

Referring to the drawings, FIG. 1 illustrates an embodiment of an invention to allow customers to manipulate and process free standing inserts (FSI's) and initiate an online shopping process using free-standing inserts (FSI's) or coupons with etailers and in embodiments, to associate scanned FSI's to one or more selected etailers. In embodiments, the customer devices are represented by the blocks 110-150 in the figure. The customer devices are illustrated in the figure as touchpads, but may be any customer device, such as a cell phone, touchpad, personal computer or other customer personal digital assistant. A system server 160 is provided to process images of FSI's imaged or scanned by these customer devices, create electronic coupons, and associate these electronic coupons with respective customer loyalty cards issued by various retailers and/or etailers for shopping at their respective operations. Alternatively or in addition, the system server 160 may be configured to initiate an etailer shopping process using the created electronic coupons via one or more electronic networks 100. In the figure, the etailers are designated by the blocks 170-195.

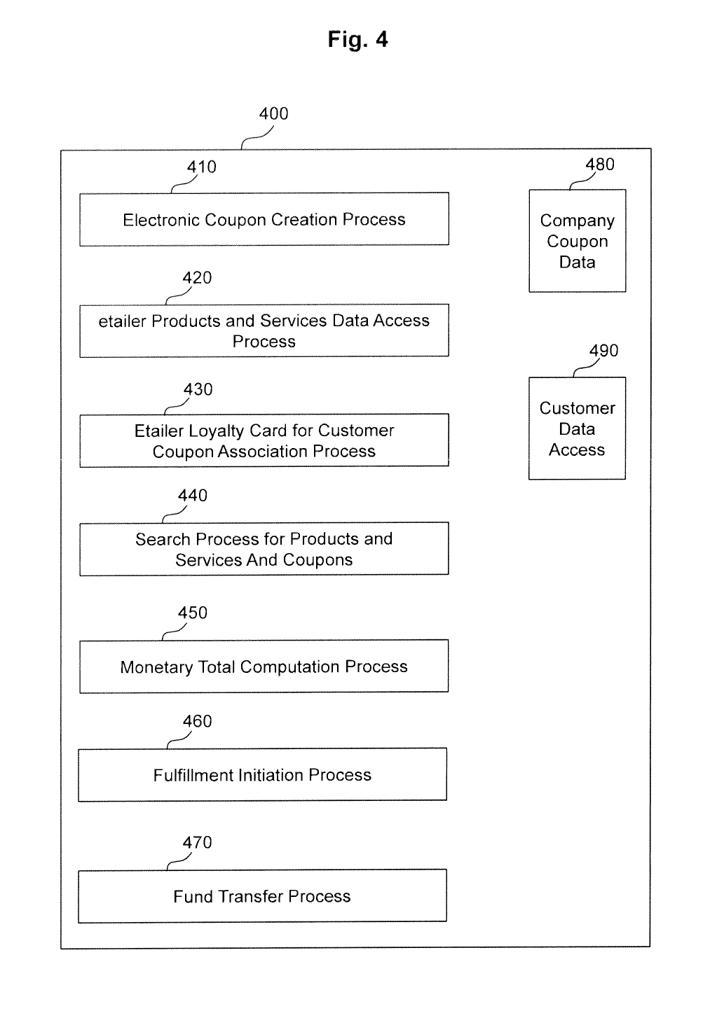

Referring now to FIG. 4, the system server 160, is embodied in one or more computers and is represented in the figure as block 400. The system server 160 may be configured with an electronic coupon creation process 410 comprising computer code for creating an electronic coupon based on an image or scan received from a customer device. In embodiments, this process may access one or more advertiser coupon databases 480 containing information on coupon redemption parameters for creating an electronic coupon. In embodiments, the electronic coupon may comprise a file structure with various parameters to be discussed below.

In embodiments, the system server 160, may be further configured with an etailer products and services access process 420. In embodiments, this access process 420 may comprise a connection via the one or more electronic networks 100 to servers of the respective etailers 170-195. In embodiments, this access process may be via respective API's that directly or indirectly link via the Internet to the respective etailers. In embodiments, the access process 420 may link to servers of the system 160, which then feed product and/or service data to the respective customer device.

In embodiments, the system server 160, may be further configured with computer code for a retailer and/or etailer loyalty card association process 430 for associating electronic coupons created from captured images of the FSI's to the loyalty cards of the respective customers from which the images of the FSI's were received. In some embodiments, this process may comprise accessing a database 490 maintained by the system of customer loyalty cards for respective retailers and/or etailers for shopping at their respective establishments. In some embodiments, this may comprise accessing databases 490 maintained by the respective retailers to make this electronic association. A purpose of issuing the loyalty cards by retailers is to promote shopping at their establishments via the use of various promotions. A purpose of this electronic association of the coupon to the loyalty card is to allow the customer to access and redeem the electronic coupon with the retailer and/or etailer when shopping with the respective retailer and/or etailer at a later time. In embodiments, this electronic association to the loyalty card may allow access to the electronic coupon during a future electronic or bricks and mortar shopping process. Note that in embodiments a single entity may be both a retailer with a bricks and mortar store and an etailer.

In embodiments, the system server 160, may be further configured with computer code for performing a search process 440 for products and services of various etailers, and a search process for coupons. In embodiments, this process may be implemented via one or more API's.

In embodiments, the system server 160, may be further configured with computer code for a monetary total computation process 450. In embodiments, this may comprise a summation algorithm process.

In embodiments, the system server 160, may be further configured with computer code for a fulfillment initiation process 460 for communicating purchase data to a respective one of the etailers 170-195, the purchase data including product(s) and/or service(s) to be delivered, and delivery data obtained from the customer database 490, or an access to delivery data in the customer database 490, e.g., address data in the database 490, or a link to delivery data, for the product(s) and/or services purchased.

In embodiments, the system server 160 may be further configured with computer code for a fund transfer process 470. In embodiments, this may comprise accessing the customer database 490 to obtain customer payment data for a fund transfer, e.g., a financial account of the customer to make a direct fund transfer to the etailer from a customer credit card account or a debit card account.

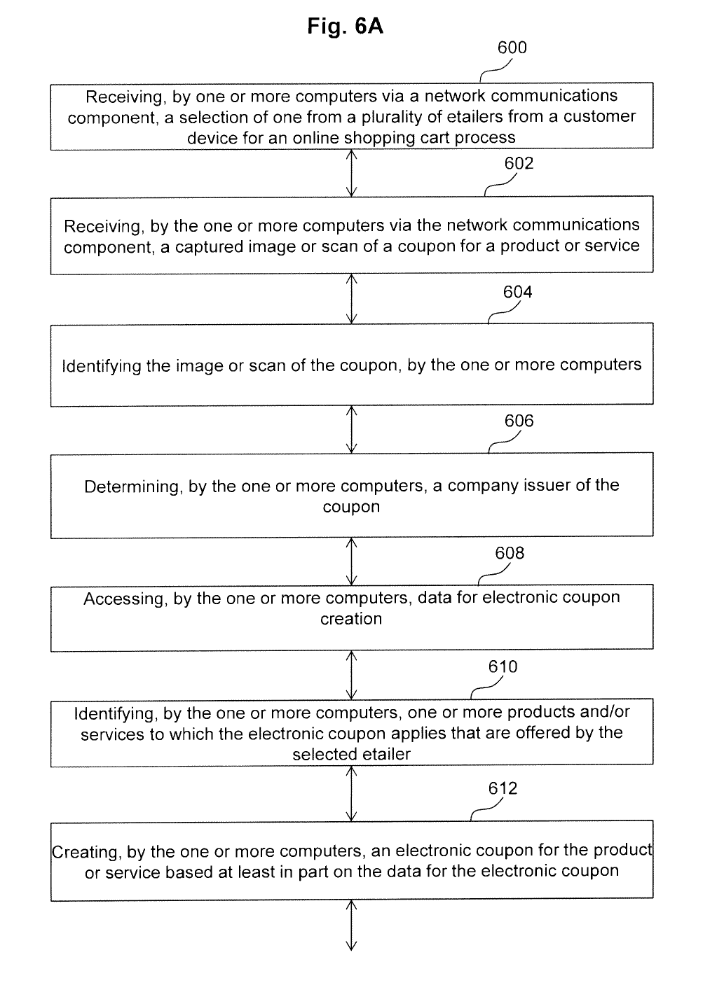

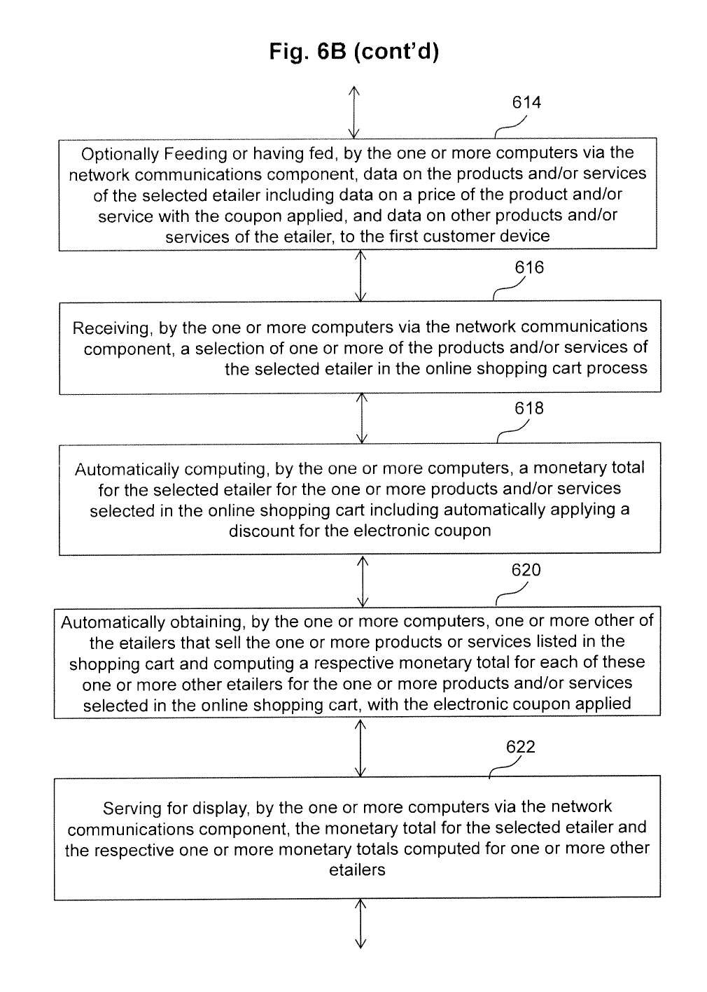

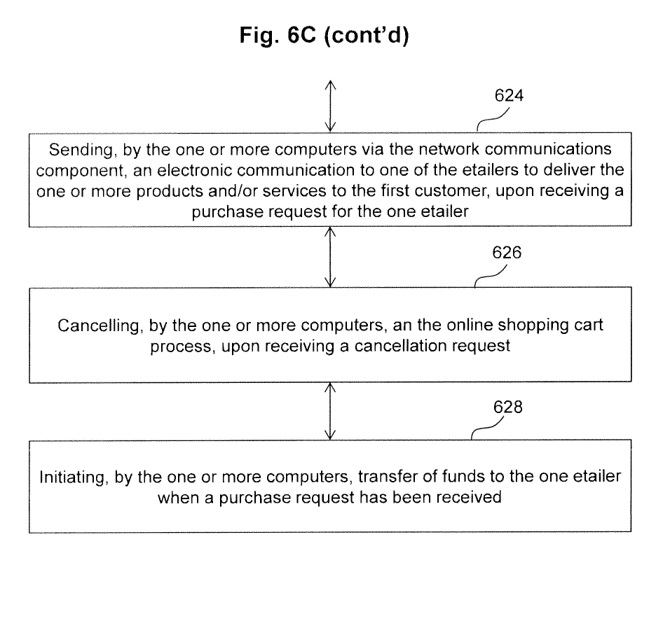

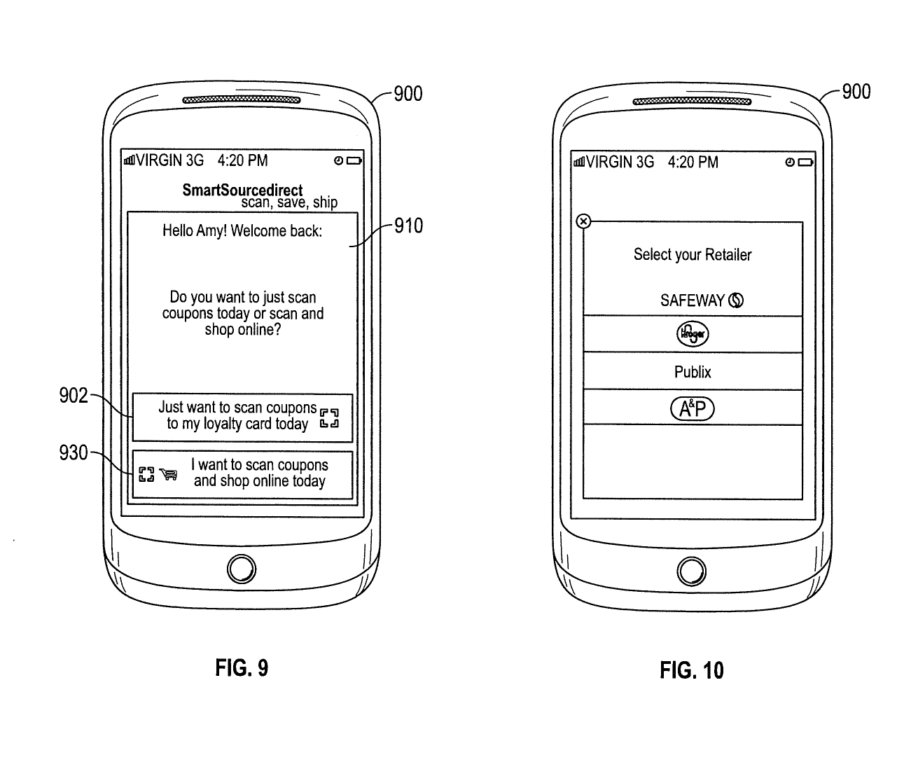

Referring to FIG. 6, embodiments of a process are disclosed to initiate an online shopping process for a customer. Block 600 represents an operation of responding to initiation of an online shopping cart process. For example referring to FIG. 9, such initiation may result from a selection of a button by a customer on his/her customer device for an API 830 “I Want to Scan Coupons and Shop Online Today,” on a screen 910 on the customer device. In embodiments, a selection of the API 930 by the customer may result in a screen 1010 (FIG. 10) on the customer device 900 with a list of etailers. A selection of one of the etailers listed on the screen results in a transmission of the etailer selection data from the customer device to the system server 160. Thus, in embodiments, block 600 represents an operation of receiving, by the one or more computers of the system server 160 via a network communications component, a selection of one from a plurality of etailers from a first one of the customer devices for the online shopping cart process. In embodiments, upon receiving a signal from the customer device initiating the “I Want to Scan Coupons and Shop Online Today” API, the system server may transmit the list of etailers to the customer device, to facilitate the customer selection. In embodiments, the list of etailers may already be stored in the customer device.

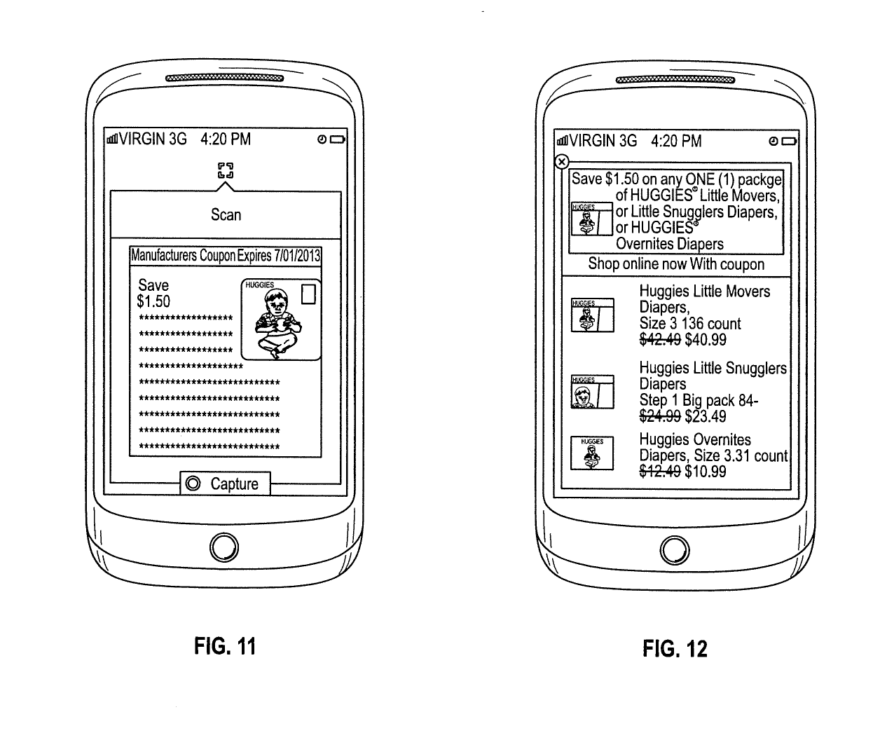

In embodiments, an operation 602 may be performed of receiving, by the one or more computers of the server system via the network communications component, a captured image or scan of a coupon for a product or service. An example of such a coupon captured image is illustrated in FIG. 11, which shows a customer device screen.

In some embodiments, the process may be reversed so that a coupon captured image or scan for a product or service may be received, and then a list of etailer may be served to the customer device that can fulfill that product or service. In embodiments, the etailer may be selected automatically based at least in part on the product or service image captured. Thus, the order of steps is not limiting on the invention.

In embodiments, an operation 604 may be performed of identifying the image or scan, by the one or more computers. In embodiments, this operation may comprise comparing the image to images in a database 480 of coupon images. In embodiments, this operation may comprise reading and interpreting a bar code or other data on the captured image.

In embodiments, an operation 606 may be performed of determining, by the one or more computers, a company issuer of the coupon. In embodiments, the accessing and making the identification operations may be performed via a lookup table.

In embodiments, an operation 608 may be performed of accessing, by the one or more computers, data associated with the company issuer for electronic coupon creation. In embodiments, this data may comprise one or more of an identification of the one or more products to which the electronic coupon will be applicable, price discount data, points awarded, a time limit for the coupon redemption, a limit on the number of products or services that can be purchased by the customer using the coupon, an advertiser code, authorized UPC codes for qualifying brands, a promo code so it can be tracked (which the brand issues) and other digital assets specific to the coupon offer, to name a few. In embodiments, the data may comprise an authorization code or data of the brand to allow its coupon to be “scanned” or imaged so that the coupon discount will be recognized and processed by the brand. One or more of these items of data may be included in the electronic coupon data. An operation 610 is performed of identifying, by the one or more computers, one or more products and/or services to which the electronic coupon applies that are offered by the selected etailer. In embodiments, these operations may 606, 608 and 610 may comprise a single step. In embodiments, these operations may comprise multiple steps. The order of these steps is not limiting on the invention.

In embodiments, an operation 612 may be performed of creating, by the one or more computers, an electronic coupon for the product or service based at least in part on the data obtained for the electronic coupon. In embodiments, as noted the electronic coupon may comprise therein one or more selected from the group of an authorized UPC code, a promotion code, and/or other digital code from the company issuer of the coupon.

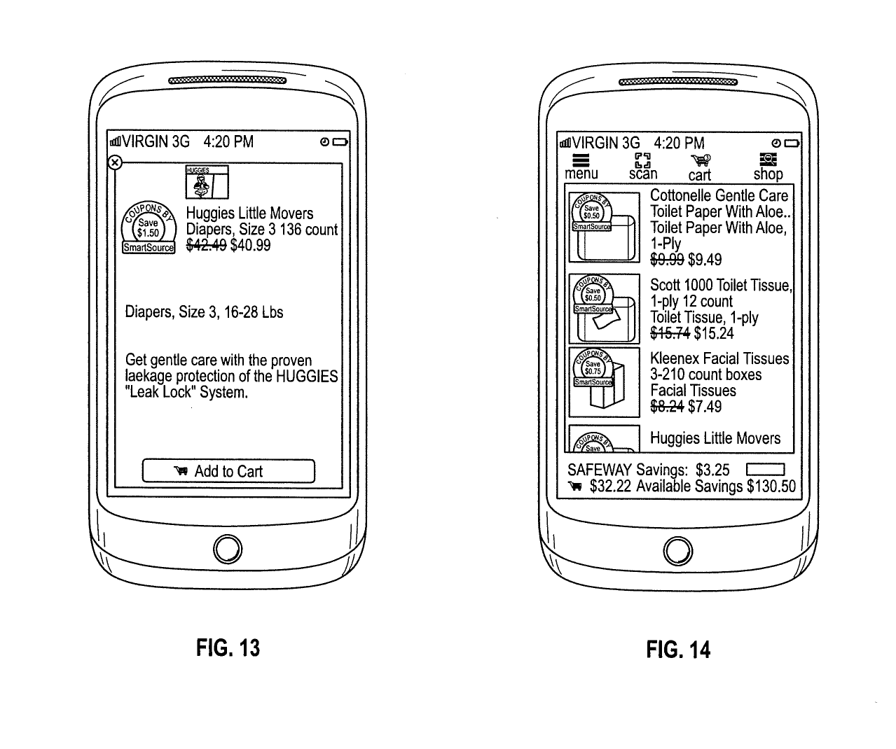

In embodiments, an operation 614 may be performed of feeding, by the one or more computers via the network communications component, data on the one or more products and/or services of the selected etailer associated with the coupon, including data on a price of the product and/or service with the created electronic coupon applied. For example, see the screenshot for the customer device of FIGS. 12 and 13. In embodiments other products and/or services of the etailer may be fed to the customer device. In embodiments, this operation may be performed via an API on the customer device that connects directly, or connect indirectly via the system server hosting, to an etailer website. For example, see the screenshot for the customer device of FIG. 14, listing other products available from the etailer. In embodiments, the hosting of the access to the etailer website allows control and/or monitoring of the operations and control of etailer access to the customer.

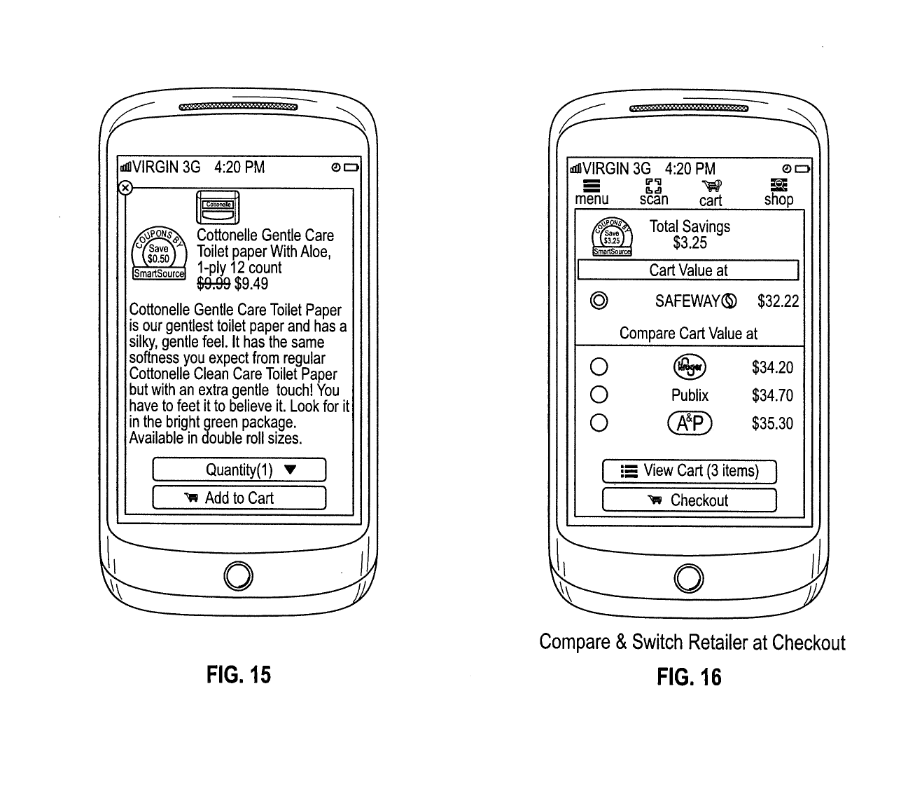

In embodiments, an operation 616 may be performed of receiving, by the one or more computers via the network communications component, a selection of one or more of the products and/or services of the selected etailer for a shopping cart in an online shopping cart process. See FIG. 15.

In embodiments, an operation 618 may be performed of automatically computing, by the one or more computers, a monetary total for the selected etailer for the one or more products and/or services selected in the online shopping cart process including automatically applying a discount for the coupon. In embodiments, this operation may comprise accessing the monetary total computation process 450 of FIG. 4.

In embodiments, an operation 620 may be performed of automatically obtaining, by the one or more computers, one or more other of the etailers that sell the one or more products or services listed in the shopping cart and computing a respective monetary total for each of these one or more other etailers for the one or more products and/or services selected in the shopping cart, with the created electronic coupon applied where applicable. In embodiments, this operation may comprise determining which etailers can fulfill all of the products and/or services in the customer's shopping cart, and only providing price total comparison data for those etailers that can fulfill all of the products and/or services in the shopping cart. In embodiments, this operation may comprise sending a transmission to the customer listing etailers and the product or services in the customer shopping cart that cannot be fulfilled by the respective etailer.

In embodiments, an operation 622 may be performed of serving for display, by the one or more computers via the network communications component, the monetary total for the selected etailer and the respective one or more monetary totals computed for the one or more other etailers, with a facility to switch etailers. For example, see the screen of the customer device of FIG. 16. In embodiments, the facility to switch may comprise a switching button or other indicator.

In embodiments, an operation 624 may be performed of sending, by the one or more computers via the network communications component, an electronic communication to one of the etailers to deliver the one or more products and/or services to the first customer, upon receiving a purchase request (“Checkout Now”) for the one etailer.

In embodiments, an operation 626 may be performed of cancelling, by the one or more computers, the online shopping cart process, upon receiving a cancellation request. In embodiments, such a cancellation request may be initiated from a screen on a customer device, as illustrated in FIG. 18.

In embodiments, an operation 628 may be performed of initiating transfer of funds to the one etailer when a purchase request has been received. In embodiments, this operation may comprise causing transfer of funds from a customer financial account, e.g., a credit account or debit account, to the etailer selected. In embodiments, this may comprise sending a transfer instruction to a financial entity to transfer funds from the designated customer account to the selected etailer.

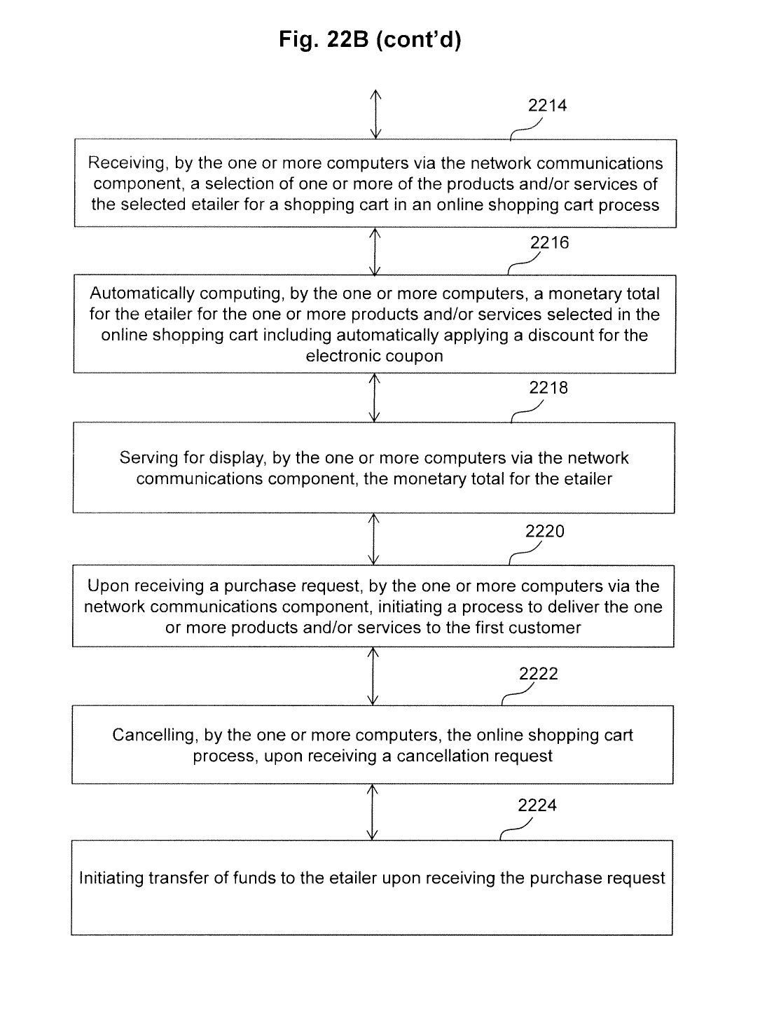

In embodiments, a similar operation may be performed when the foregoing process is performed by a licensed etailer. Referring to FIGS. 22A and 22B, further embodiments of the invention directed to such an etailer operation are provided.

In embodiments, an operation 2200 may be performed of receiving by an etailer when an online shopping cart process is initiated, by the one or more computers via the network communications component, a coupon captured image or scan for a product or service.

In embodiments, an operation 2202 may be performed of identifying the image or scan, by the one or more computers.

In embodiments, an operation 2204 may be performed of determining, by the one or more computers, a company issuer of the coupon.

In embodiments, an operation 2206 may be performed of accessing, by the one or more computers, data associated with the company issuer for electronic coupon creation. See the previous description for examples of embodiments of this operation.

In embodiments, an operation 2208 may be performed of identifying, by the one or more computers, one or more products and/or services to which the coupon applies that are offered by the retailer.

In embodiments, an operation 2210 may be performed of creating, by the one or more computers, an electronic coupon for the product or service based at least in part on the data for the electronic coupon. See the previous description for examples of embodiments of this operation. As noted, the order of these steps is not limiting on the invention.

In embodiments, an operation 2212 may be performed of feeding, by the one or more computers via the network communications component, data on the one or more products and/or services of the etailer associated with the coupon, including data on a price of the product and/or service with the created electronic coupon applied, and feeding data on other products and/or services of the etailer to the customer device.

In embodiments, an operation 2214 may be performed of receiving, by the one or more computers via the network communications component, a selection of one or more of the products and/or services of the etailer for an online shopping cart in an online shopping cart process.

In embodiments, an operation 2216 may be performed of automatically computing, by the one or more computers, a monetary total for the etailer for the one or more products and/or services selected in the online shopping cart process including automatically applying a discount for the coupon.

In embodiments, an operation 2218 may be performed of serving for display, by the one or more computers via the network communications component, the monetary total for the etailer. In some embodiments, a price comparison data for the products and/or services in the shopping cart with other etailers may be provided for display. For example, see the description of block 620 of FIG. 6.

In embodiments, an operation 2220 may be performed of initiating, by the one or more computers via the network communications component, upon receiving a purchase request, a process to deliver the one or more products and/or services to the customer.

In embodiments, an operation 2222 may be performed of cancelling, by the one or more computers, the online shopping cart process, upon receiving a cancellation request.

In embodiments, an operation 2224 may be performed of initiating transfer of funds to the etailer upon receiving the purchase request. See the previous discussion of this operation in block 628 for example embodiments.

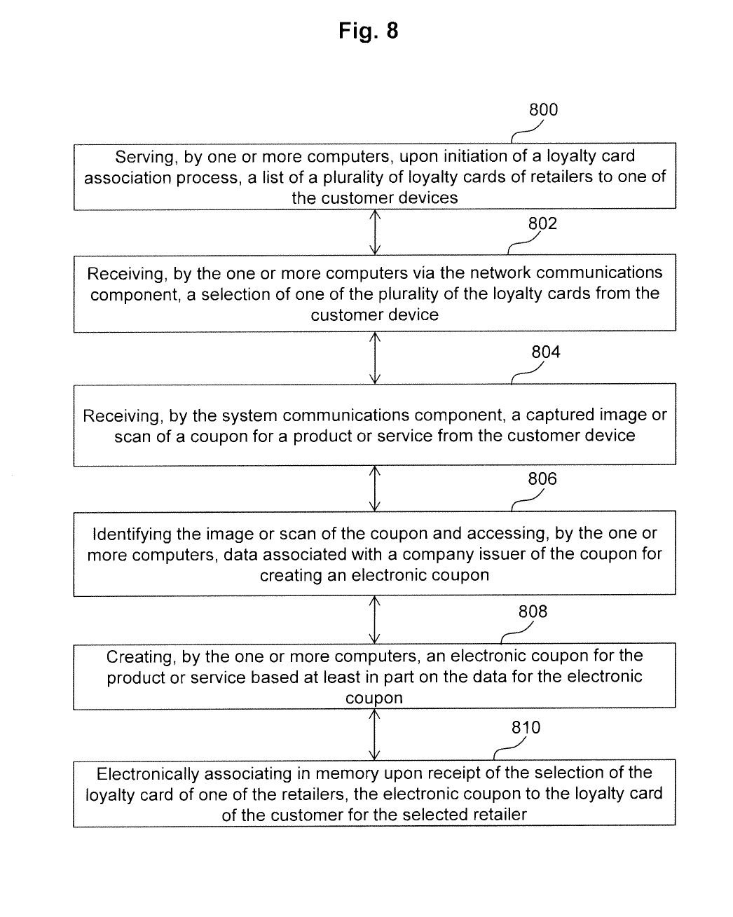

In embodiments, a process to associate a captured image or scan of a coupon may be included in the etailer embodiment of FIG. 22. Details of embodiments of this operation are provided in more with reference to FIG. 8 to be discussed later.

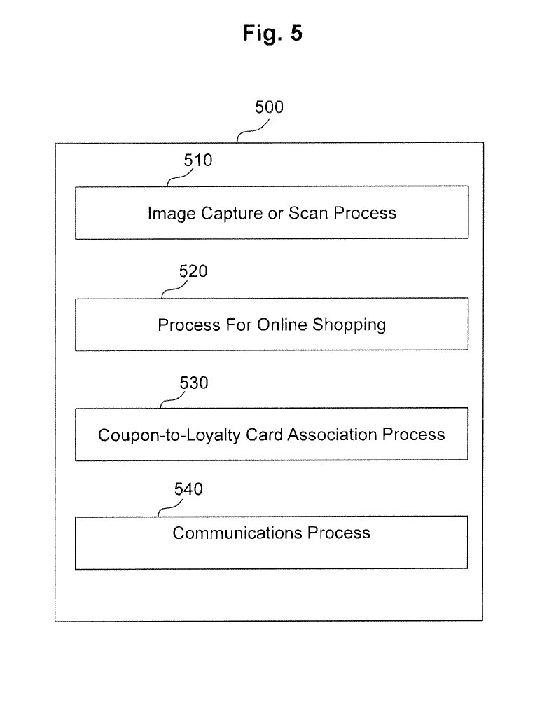

Embodiments of a customer device system configuration 500 consistent with the present invention are illustrated in FIG. 5. Block 510 comprises an image capture and/or scan process for imaging via a camera that may be embodied in the customer device the coupon, or scanning the coupon via a scanner that may be embodied in the customer device, to thereby obtain a captured image or scan of a coupon.

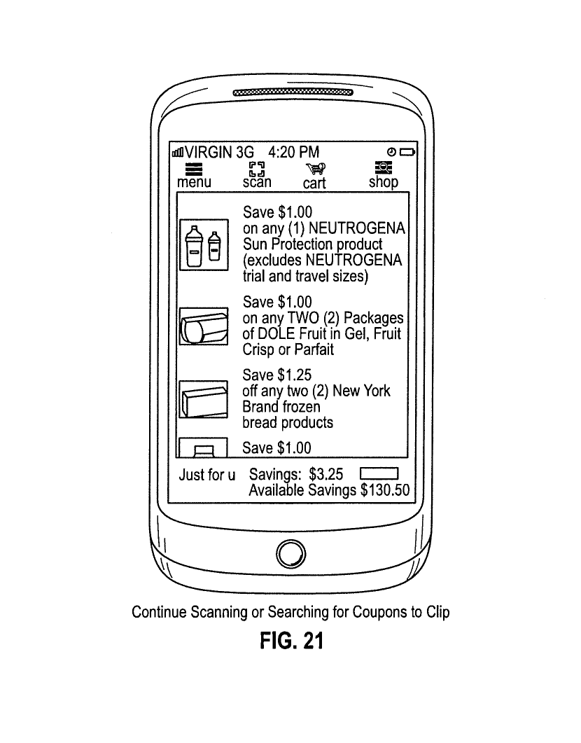

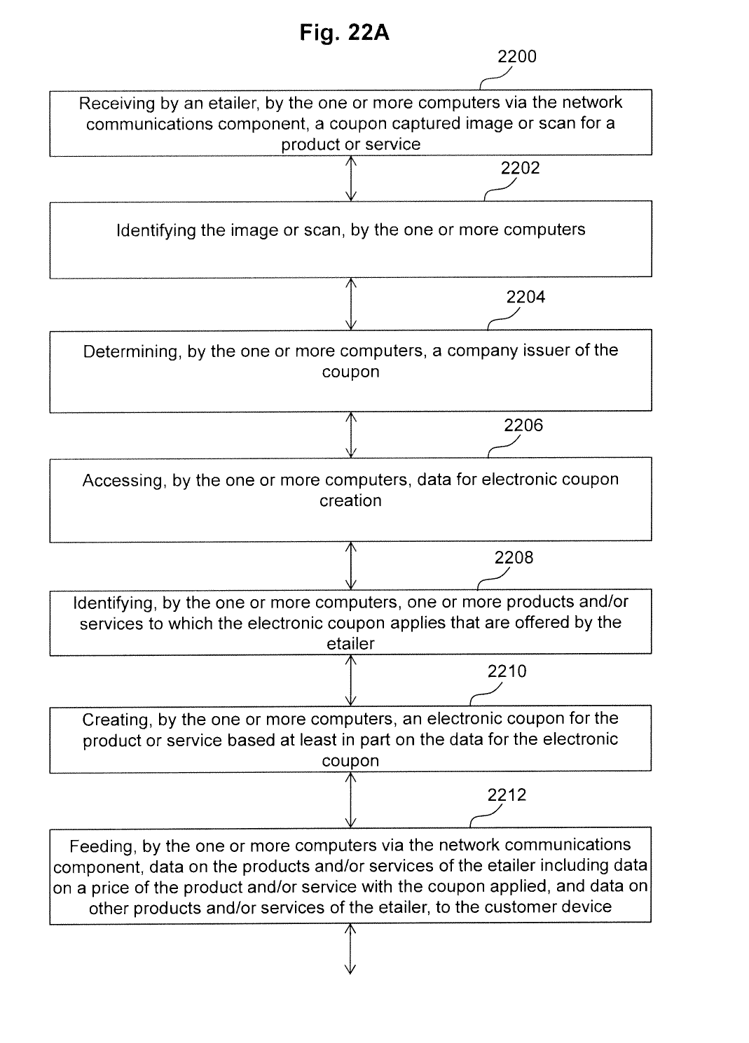

Block 520 comprises a process for initiating and performing an online shopping session. In embodiments this process may include a series of API's with screens, e.g., FIGS. 9-21, to move the customer thru the shopping process, to be discussed below in more detail.

Block 530 comprises a coupon-to-loyalty card process for initiating an image capture or scan of a coupon and a transmission of the captured coupon image or scan to the system server for association with a selected one or more loyalty cards.

Block 540 comprises a communications module for facilitating communication over one or more networks. In embodiments, the communications module may be used to communicate captured images or scans of coupons and various command sequences to and from the system server.

Accordingly, in embodiments, the customer device may comprise a communications component configured to communicate electronically over one or more networks, an image capture or scanner component, a graphical user interface (GUI) screen, a memory, and a computer processor. In embodiments, the processor may be operatively connected to the image capture or scanner component, the GUI screen, and the memory.

In embodiments, the processor may be configured with a process operative to initiate, by the processor using the image capture or scanner component, an image capture or scan of a coupon, to be transmitted to the system server 160 to access data for creation by the system server of an electronic coupon, and to associate the electronic coupon with a loyalty card of a retailer and/or etailer. In embodiments, the processor may be configured with a process to initiate, to initiate an online shopping cart process via the Internet by the communications component and to image capture or scan of a coupon for the shopping process.

In embodiments, the process to image capture or scan and associate a coupon to a loyalty card comprises sub-processes and menus for display on the GUI screen. In embodiments a sub-process may display, by the processor on the GUI screen, multiple loyalty cards of retailers and/or etailers, and a capability to receive a selection of a loyalty card of one of the retailers or etailers from a customer. In embodiments a sub-process may activate, by the processor, the image capture or scanner component to image capture or scan a selected coupon for a product or service and to transmit, by the communications component, the coupon image capture or scan to a server for creation of an electronic coupon and associate it to the selected loyalty card.

In embodiments, the process of initiating the online shopping cart process may comprise sub-processes and menus for display on the GUI screen. In embodiments, the process comprises a sub-process that configures the device to display, by the processor on the GUI screen, multiple etailers and to receive a selection of one of the etailers from the customer. In embodiments, the process comprises a sub-process that configures the device to activate, by the processor, the image capture or scanner component to image capture or scan a coupon for a product or service and to transmit, by the communications component, the captured image or scan of the coupon to the server for creation of an electronic coupon. In embodiments, the process comprises a sub-process that configures the device to access via the communications component and display on the GUI screen data for one or more products and/or services offered by the selected etailer to which the coupon applies, as well as other products and/or services of the selected etailer, and to receive a selection of one or more products and/or services from the customer for the online shopping cart process.

The process may further comprise a sub-process to receive, via the communications component and display on the screen: 1) a monetary total for the selected etailer for the one or more products and/or services selected in the online shopping cart with a discount automatically applied for the created electronic coupon where applicable; and 2) a respective monetary total for each of one or more other of the etailers for the one or more products and/or services selected in the online shopping cart with the created electronic coupon automatically applied as applicable in computing the respective one or more monetary totals; (3) to generate, by the processor, a display on the screen with: a button or other indicator to switch to one of the one or more other etailers, a button or other indicator to cancel one or more products or services from the online shopping cart or to cancel the entire online shopping cart process, with a button or other indicator to send an electronic communication to purchase and have delivered the products and/or services from one of the etailers to the customer. In embodiments, the process comprises a sub-process that configures the device to initiate transfer of funds to the one etailer upon the button or other indicator being activated to purchase. In embodiments, no customer identification data is provided to the company issuer of the coupon.

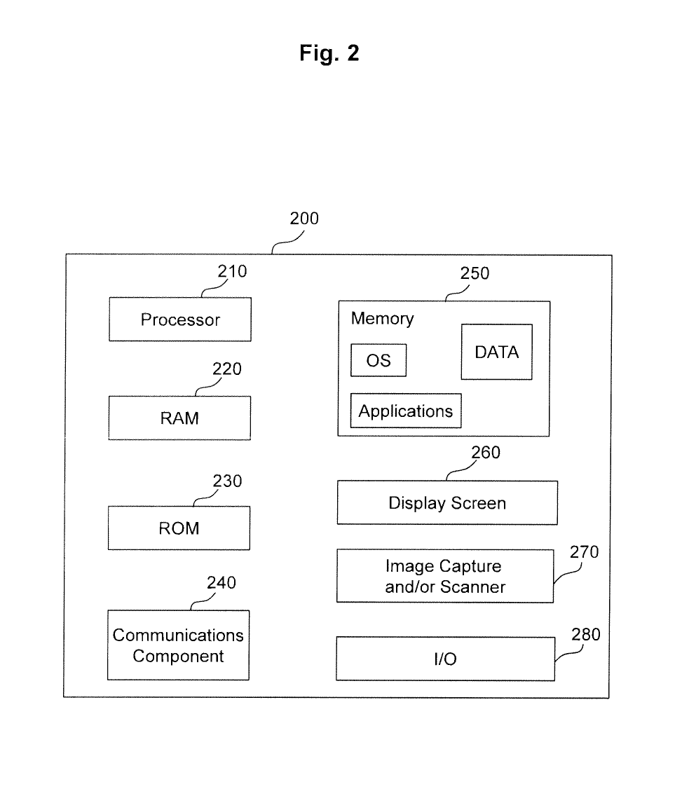

Embodiments of a customer device are shown in FIG. 2. The device may comprise a communications component 240 configured to communicate electronically over one or more networks; an image capture or scanner component 270; a graphical user interface (GUI) screen 260; a memory 250 configured to store one or more API's for access to one or more system servers; and a computer processor 210 operatively connected to the image capture or scanner component 270, the GUI screen 260, and the memory 250, as illustrated in FIG. 2. In embodiments, the system server configuration may have one server. In embodiments, the system server configuration may have multiple servers.

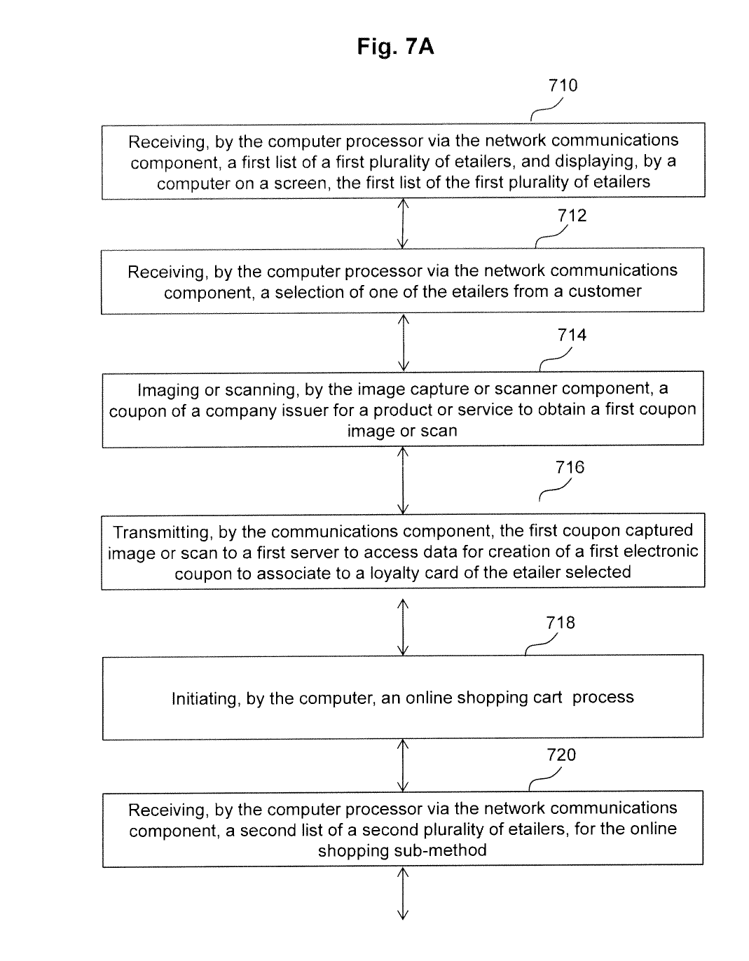

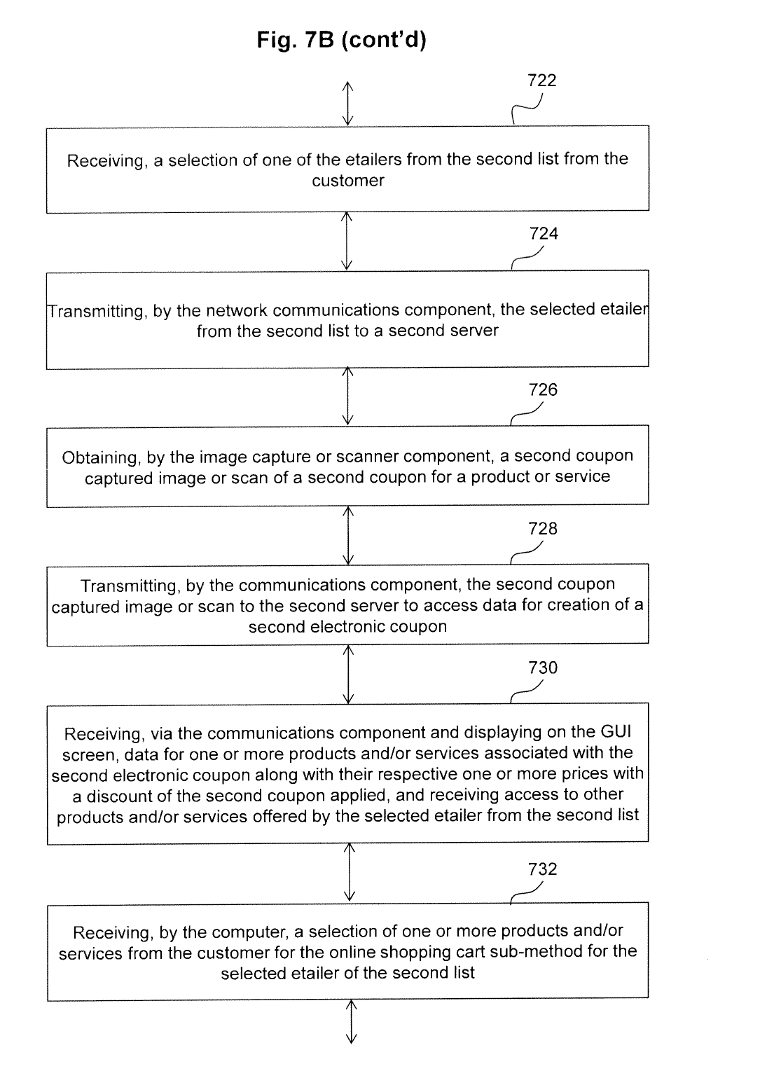

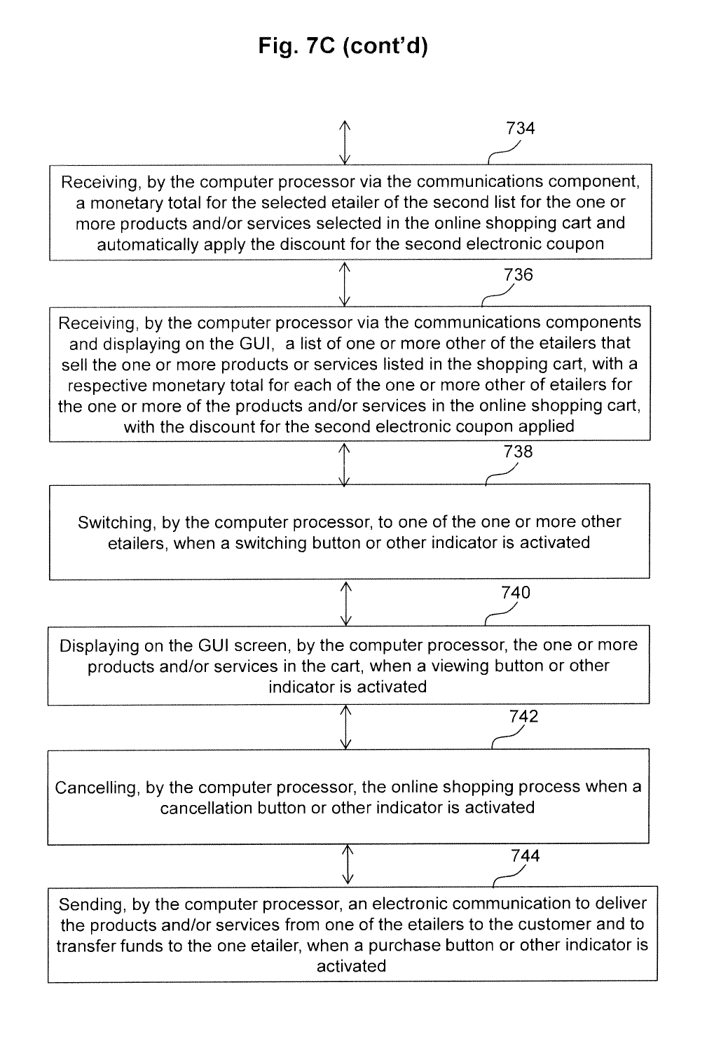

Referring to FIG. 7, embodiments of a method consistent with the invention may comprise a loyalty card association sub-method for a customer device. See FIG. 9, which is an example screen listing the loyalty card association sub-method 902 for selection.

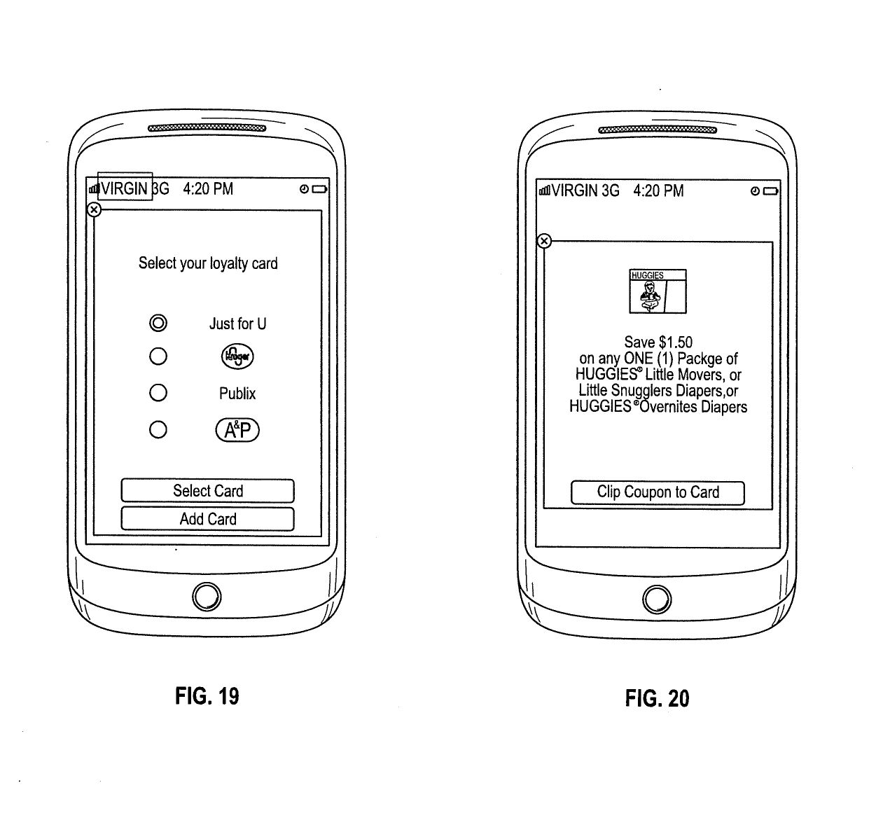

In embodiments, the loyalty card association sub-method may comprise an operation of receiving, by the computer processor via the network communications component, a first list of a first plurality of etailers, and displaying, by a computer on a screen, the first list of the first plurality of etailers. This operation is represented by block 710. See FIG. 19, which is an example customer device screen with such a first list of etailers.

Block 712 comprises an operation of receiving, by the computer processor via the network communications component, a selection of one of the etailers of the first list from a customer.

Block 714 comprises an operation of imaging or scanning, by the image capture or scanner component, a coupon of a company issuer for a product or service to obtain a first coupon image or scan. See FIG. 11, which is an example screen illustrating a coupon image capture. As noted previously, this operation may, in embodiments, occur before the operation of block 710, to be followed by the operation of block 710. In embodiments, this operation may occur after the operation of block 710. Thus, the order of the steps is not limiting on the invention.

Block 716 comprises an operation of transmitting, by the communications component, the first coupon captured image or scan to a first server to facilitate identification of data for creation of a first electronic coupon and to associate the created electronic coupon to the selected loyalty card.

In embodiments, alternatively or in addition the method may further comprise an online shopping cart sub-method. The online shopping cart sub-method may comprise, in embodiments, a block 718 comprising an operation of initiating the online shopping sub-method. See the display 910 in FIG. 9 which lists the online shopping cart sub-method 930 as available for selection.

Block 720 comprises an operation of receiving, by the computer processor via the network communications component, a second list of a second plurality of etailers, for the online shopping cart sub-method. See FIG. 10 which is a screen shot of an example second list.

Block 722 comprises an operation of receiving a selection of one of the etailers from the second list from the customer.

Block 724 comprises an operation of transmitting, by the network communications component, the selected etailer from the second list to a second server.

Block 726 comprises an operation of obtaining, by the image capture or scanner component, a captured image or scan of a second coupon for a product or service. See FIG. 11 which is a screen shot of an example coupon image being captured.

Block 728 comprises an operation of transmitting, by the communications component, the second coupon captured image or scan to the second server to use to identify directly or indirectly data in a database to create a second electronic coupon. Note that in embodiments, the first and the second servers may be implemented with a single server.

Block 730 comprises an operation of receiving, via the communications component and displaying on the GUI screen, data for one or more products and/or services associated with the second coupon along with their respective one or more prices with a discount of the created electronic second coupon applied. See FIG. 12 which is a screen shot of an example set of products to which the created electronic coupon may be applied. In embodiments, access to other products and/or services offered by the selected etailer from the second list may be provided.

Block 732 comprises an operation of receiving, by the computer, a selection of one or more products and/or services from the customer for the online shopping cart sub-method for the selected etailer of the second list.

Block 734 comprises an operation of receiving, by the computer processor via the communications component, a monetary total for the selected etailer of the second list for the one or more products and/or services selected in the online shopping cart and automatically applying the discount for the second coupon to the one or more products and/or services to which it is applicable. See the example customer screen of FIG. 16.

Block 736 comprises an operation of receiving, by the computer processor via the communications components and displaying on the GUI, a list of one or more other of the etailers that sell the one or more products or services listed in the shopping cart, with a respective monetary total for each of the one or more other of etailers for the one or more of the products and/or services in the online shopping cart, with the discount for the created electronic second coupon applied where applicable, with a switching button or other indicator to switch etailers. See the example customer device screen of FIG. 16.

Block 738 comprises an operation of switching, by the computer processor, to one of the one or more other etailers, when the switching button or other indicator is activated. See FIG. 16 which is a customer device screen shot illustrating open circles indicating that the other etailers may be selected.

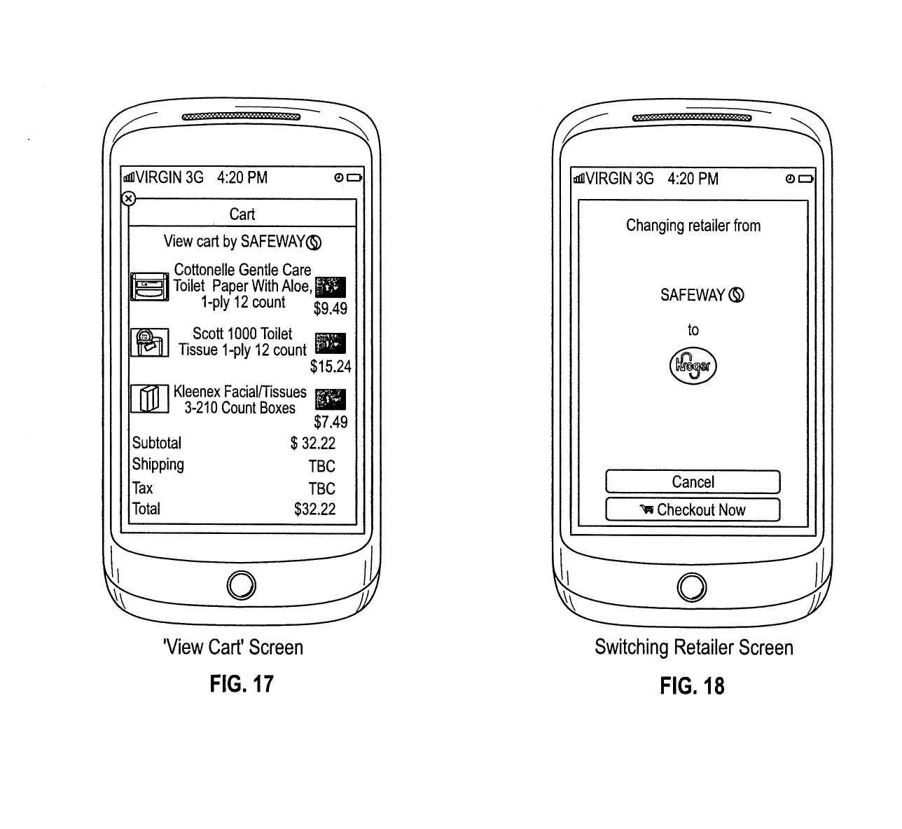

Block 740 comprises an operation of displaying on the GUI screen, by the computer processor, the one or more products and/or services in the online shopping cart, when a viewing button or other indicator is activated. See FIG. 17 which is an example customer device screenshot of this process.

In embodiments, block 742 comprises an operation of cancelling, by the computer processor, the online shopping process when a cancellation button or other indicator is activated. See FIG. 18 which includes a Cancel button.

Block 744 comprises an operation of sending, by the computer processor, an electronic communication to deliver the one or more products and/or services from one of the etailers to the customer and to transfer funds to the one etailer, when a purchase button or other indicator is activated by the customer. See FIG. 18 which includes a customer device screenshot with a Checkout Now button.

In embodiments, the operation further may comprise taking actions to prevent customer identification data being provided to the company issuer of the one or more coupons that were applied. In embodiments, this may comprise agreements with the respective etailers not to communicate this information to the company issuer of the coupon. Thus, in embodiments, the system server method may further be configured to facilitate executing or having executed and/or storing a respective contract with each of the plurality of etailers to withhold and not disclose customer identification data to the company issuers of the one or more FSI coupons used to create electronic coupons that were applied.

In embodiments, the system server may further be configured with program code to determine, when an etailer is selected for association of the coupon to its loyalty card, if the etailer selected can fulfill one or more of the products or services of the coupon captured image or scan. In embodiments, this operation may further comprise serving a message that the etailer selected cannot fulfill the product or service of the coupon captured image or scan, when that has been determined.

In embodiments, the system server operation to obtain one or more other of the etailers that sell the products or services listed in the online shopping cart may comprise, for each of multiple of the respective etailers, searching the products and/or services offered by the respective etailer to determine if all of the one or more products and/or services in the online shopping cart process match products and/or services offered and/or available from the respective etailer.

In embodiments, there may be a plurality of products and/or services selected in the online shopping cart, and the system server may be configured with program code to compute for each of the etailers, a respective monetary total by adding together respective prices for the respective products and/or services selected to obtain the respective monetary total with the created electronic coupon applied where appropriate.

In embodiments, the system server may further be configured with program code to transfer or initiate transfer of funds for the online shopping purchase in real time.

In embodiments, the system server may further be configured with program code to accumulate purchased products and/or services over a period of time for a given one of the etailers and to send the products and/or service accumulated to the given etailer in a batch transfer. In embodiments, the server may also be configured to initiate the transfer of funds from a plurality of the accounts associated with the customers or the customer devices to the given one of the etailers at a time of the batch transfer.

In embodiments, the system server may further be configured with program code to serve, by the one or more computers via the communications component, one or more of the plurality of etailers to the first customer device based at least in part on a product or service identified for the coupon.

In embodiments, the memory may be configured to store, for each of the plurality of customers, loyalty card data and associated coupons for each of a plurality of retailer loyalty cards associated with the customer. Referring to FIG. 8, the system server may further be configured with program code to perform this association process. Block 800 represents an operation of serving, by the one or more computers, upon initiation of a loyalty card association process from a customer device, a list of a plurality of loyalty cards of retailers and/or etailers for the respective customer.

Block 802 represents an operation of receiving, by the one or more computers via the network communications component, a selection of one of the plurality of the loyalty cards from the customer device.

Block 804 represents an operation of receiving, by the system communications component, a captured image or scan of a coupon for a product or service from the customer device.

Block 806 represents an operation of identifying the image or scan of the coupon, and accessing, by the one or more computers, data associated with a company issuer of the coupon for creating an electronic coupon.

Block 808 represents an operation of creating, by the one or more computers, an electronic coupon for the product or service based at least in part on the data for creating the electronic coupon.

Block 810 represents an operation of electronically associating in the memory, by the one or more computers, upon receipt of the selection of the loyalty card of one of the retailers or etailers, the electronic coupon to the selected retailer or etailer loyalty card of the customer.

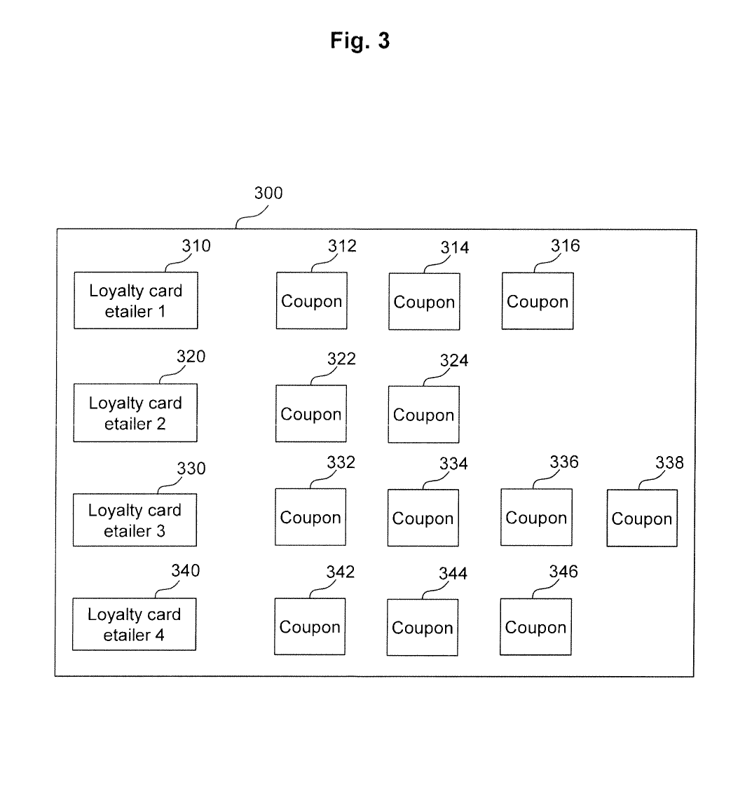

FIG. 3 is a schematic representation of loyalty cards 310-340 of a respective customer 810 with electronic coupons associated thereto.

FIG. 2 illustrates an exemplary implementation of a customer device 200 in accordance with various embodiments. As noted, the customer device 200 may be a tablet laptop, an e-reader, an iPad™, cell phone, personal computer, or any personal assistant electronic device. The type of device for the customer is not limiting on the invention. In embodiments, the customer device 200 may comprise a processor 210, a memory that includes an operating system for the device, data, and various applications. In some embodiments, the customer device may further include RAM 220 and Rom 230. The customer device may further comprise a communications component 240, a display screen or graphical user interface (GUI) 260, an image capture and/or scanner component 270, and an input/output devices, e.g., a touchpad capability, a keypad, a microphone, an audio speaker 280. In embodiments, other components not shown may comprise a battery and one or more antennas.

Referring to FIG. 1 again, the system server 160 in embodiments may be implemented using a desktop, laptop or notebook computer, mainframe, server, client, or any other type of special or general purpose computing device as may be desirable or appropriate for a given application or environment. The system server 160 includes one or more processors, that may be implemented using a general or special purpose processing engine such as, for example, a microprocessor, microcontroller or other control logic. In embodiments, the processor may be connected to a bus or other communication medium.

The system server 160 may also include a main memory, such as random access memory (RAM) or other dynamic memory, for storing information and instructions to be executed by the processor. Main memory also may be used for storing temporary variables or other intermediate information during execution of instructions by processor. The system server 160 may likewise include a read only memory (“ROM”) or other static storage device coupled for storing static information and instructions for the processor. The system server 160 may also include an information storage system, which may include, for example, a media drive and a removable storage interface.

Communications described herein may be effectuated via any combination of wired or wireless networks including, but not limited to, a mobile telephone network, a wireless Local Area Network (LAN), a Bluetooth personal area network, an Ethernet LAN, a token ring LAN, a wide area network, the Internet, etc. For exemplification, a mobile telephone network may provide connectivity of a consumer/user device with the Internet. Connectivity to the Internet may include, but is not limited to, long range wireless connections, short range wireless connections, and various wired connections including, but not limited to, telephone lines, cable lines, power lines, and the like. The consumer/user devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A consumer/user device may communicate using various media including, but not limited to, radio, infrared, laser, cable connection, and the like.

Various embodiments are described herein with reference to drawings. These drawings illustrate certain details of specific embodiments that implement the systems and methods and programs of the present invention. However, describing the invention with drawings should not be construed as imposing on the invention any limitations that may be present in the drawings. Various embodiments contemplate methods, systems and program products on any tangible machine-readable media for accomplishing its operations. The embodiments of the present invention may be implemented using an existing computer processor, or by a special purpose computer processor incorporated for this or another purpose or in whole or in part by a hardwired system.

As noted above, various embodiments include computer program products embodied or encoded on, e.g., a non-transitory computer/machine-readable media (e.g., memory) for carrying or having machine-executable instructions or data structures stored thereon. Such computer/machine-readable media can be any available tangible media which can be accessed by a general purpose or special purpose computer, server, or other machine with a processor or controller. By way of example, such computer/machine-readable media can comprise RAM, ROM, EPROM, EEPROM, CD-ROM or other optical disk storage, magnetic disk storage or other magnetic storage devices, or any other non-transitory medium which can be used to carry or store desired program code in the form of machine-executable instructions or data structures. Machine-executable instructions comprise, for example, instructions and data which cause a general purpose computer, special purpose computer, or special purpose processing machine to perform a certain function or group of functions.

Various embodiments are also described in the general context of method processes which may be implemented in embodiments by a program product including machine-executable instructions, in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing processes of the methods disclosed herein. The particular sequence of such executable instructions or associated data structures represent examples of corresponding acts for implementing the functions described in such processes and it is understood that the order of these processes may differ from what is depicted. Also two or more processes may be performed concurrently or with partial concurrence. Such variation will depend on the software and hardware systems chosen and on designer choice. It is understood that all such variations are within the scope of the invention. Likewise, software and web implementations of the present invention could be accomplished with standard or non-standard programming techniques, with rule based logic, and other logic to accomplish the various database searching processes, correlation processes, comparison processes and decision processes. It should also be noted that the words “component” and “module” as used herein and/or in the claims is intended to encompass implementations using one or more lines of software code, and/or hardware implementations, and/or equipment for receiving manual inputs.

As noted, embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

All components, modes of communication, and/or processes described heretofore are interchangeable and combinable with similar components, modes of communication, and/or processes disclosed elsewhere in the specification. It is intended that any structure or step of an embodiment disclosed herein may be combined with other structure and or method embodiments disclosed herein to form an embodiment with this added element or step, unless a statement herein explicitly prohibits this combination.

The foregoing description of embodiments of the invention has been presented for purposes of illustration and description. It is not intended to be exhaustive or to limit the invention to the precise form disclosed. The embodiments were chosen and described in order to explain the principals of the invention and its practical application to enable one skilled in the art to utilize the invention in various embodiments and with various modifications as are suited to the particular use contemplated. Other substitutions, modifications, changes and omissions may be made in the design, operating conditions and arrangements of the preferred and other exemplary embodiments without departing from the spirit of the present invention.

We claim:

1. A system comprising:
a system communication component configured to communicate electronically over one or more networks with a plurality of customer devices and with a plurality of etailers;
a memory configured to store for each of the plurality of customers:
customer address data;
at least one payment account number;
a server configured in one or more computers for an online shopping cart process:
to receive, by the one or more computers via a network communications component, a selection of one from a plurality of etailers from a first one of the customer devices for the online shopping cart process for a first customer;
to receive, by the one or more computers via the network communications component, a captured image or scan of a coupon for a product or service;
to identify the image or scan, by the one or more computers, and
determine a company issuer of the coupon;
access data associated with the company issuer for electronic coupon creation;
identify a product and/or service to which the coupon applies that is offered by the selected etailer; and
to create, by the one or more computers, an electronic coupon for the product or service based at least in part on the data for the electronic coupon;
to feed, by the one or more computers via the network communications component, data on the product and/or service of the selected etailer including data on a price of the product and/or service with the electronic coupon applied, and to feed other products and/or services of the etailer, to the first customer device;
the server configured to receive, by the one or more computers, a selection of one or more of the products and/or services of the selected etailer in the online shopping cart process;
the server configured to automatically compute, by the one or more computers, a monetary total for the selected etailer for the one or more products and/or services selected in the online shopping cart process including to automatically apply a discount for the electronic coupon;
the server configured, by the one or more computers, to automatically obtain one or more other of the etailers that sell the one or more products and/or services listed in the shopping cart and to compute a respective monetary total for each of these one or more other etailers for the one or more products and/or services selected in the online shopping cart process, with the electronic coupon applied;
the server configured, by the one or more computers via the network communications component, to serve for display the monetary total for the selected etailer and the respective one or more monetary totals computed for the one or more other etailers, with a facility to switch etailers;
the server configured, by the one or more computers via the network communications component, to send an electronic communication to one of the etailers to deliver the one or more products and/or services to the first customer, upon receiving a purchase request for the one etailer;
the server configured, by the one or more computers, to cancel an the online shopping cart process, upon receiving a cancellation request; and
the server configured to initiate transfer of funds to the one etailer when the purchase request has been received.

2. The system as defined in claim 1, wherein the system server operation to create an electronic coupon is configured to include code data from the company issuer in the electronic coupon.

3. The system as defined in claim 1, wherein the server operation to obtain one or more other of the etailers that sell the products or services listed in the shopping cart comprises for each of multiple of the respective other etailers, searching the products and/or services offered by the respective other etailer to determine if all of the one or more products and/or services in the online shopping cart process match products and/or services offered by the respective etailer.

4. The system as defined in claim 1, wherein there are a plurality of products and/or services selected in the online shopping cart, and wherein the computing steps for the monetary totals comprise for each of the selected etailer and the one or more other etailers, comprises adding together respective prices for the respective products and/or services selected to obtain the monetary total.

5. The system as defined in claim 1, wherein the server is configured with program code to transfer or initiate transfer of funds for the online shopping purchase in real time.

6. The system as defined in claim 1,
wherein the server is configured to accumulate purchased products over a period of time for a given one of the etailers and to send the products accumulated to the given etailer in a batch transfer, and
wherein the server is configured to initiate the transfer of funds from a plurality of the accounts associated with the customer devices or their owners to the given one of the etailers at a time of the batch transfer.

7. The system as defined in claim 1, further comprising:
serving, by the one or more computers via the communications component, one or more of the plurality of etailers to the first customer device based at least in part on the products and/or services identified for the coupon, upon initiation of the online shopping cart process.

8. The system as defined in claim 1,
wherein the memory is configured to store for each of the plurality of customers, loyalty card data and associated coupons for each of a plurality of retailer loyalty cards associated with the customer, and
wherein the server is configured, by the one or more computers to:
to serve, by the one or more computers, upon initiation of a loyalty card association process, a list of a plurality of loyalty cards of retailers to a second one of the customer devices;
to receive, by the one or more computers via the network communications component, a selection of one of the plurality of the loyalty cards from the second customer device;
to receive by the system communications component a captured image or scan of a coupon for a product or service from the second customer device;
to identify the image or scan of the coupon and determine, by the one or more computers, data associated with a company issuer of the coupon for creating an electronic coupon;
to create, by the one or more computers, an electronic coupon for the product or service based at least in part on the data for creating the electronic coupon; and
to electronically associate in the memory, by the one or more computers, upon receipt of the selection of the loyalty card of one of the retailers, the electronic coupon to the loyalty card of the second customer for the selected retailer.

9. The system as defined in claim 8,
wherein the server is further configured in the one or more computers to determine if the etailer selected can fulfill the product or service of the coupon captured image or scan, when the etailer is selected for association of its loyalty card to the coupon; and
wherein the server is further configured in the one or more computers to serve a message that the etailer selected does not fulfill the product or service of the coupon captured image or scan, when that is true.

10. A method for communicating with a plurality of customer devices and a plurality of etailers, comprising:
receiving, by one or more computers via a network communications component, a selection of one from a plurality of the etailers from a first one of the customer devices for an online shopping cart process;
receiving, by the one or more computers via the network communications component, a captured image or scan of a coupon for a product or service;
identifying the captured image or scan of the coupon, by the one or more computers, and
determining, by the one or more computers, a company issuer of the coupon;
accessing, by the one or more computers, data associated with the company issuer for electronic coupon creation;
identifying, by the one or more computers, a product and/or service to which the coupon applies that is offered by the selected etailer; and
creating, by the one or more computers, an electronic coupon for the product or service based at least in part on the data for the electronic coupon;
feeding, by the one or more computers via the network communications component, data on the product and/or service of the selected etailer including data on a price of the product and/or service with the electronic coupon applied, and data on other products and/or services of the etailer, to the first customer device;
receiving, by the one or more computers via the network communications component, a selection of one or more of the products and/or services of the selected etailer for an online shopping cart in the online shopping cart process;
automatically computing, by the one or more computers, a monetary total for the selected etailer for the one or more products and/or services selected in the online shopping cart including automatically applying a discount for the coupon;
automatically obtaining, by the one or more computers, one or more other of the etailers that sell the one or more products and/or services listed in the online shopping cart and computing a respective monetary total for each of these one or more other etailers for the one or more products and/or services selected in the online shopping cart, with the coupon applied;
serving for display, by the one or more computers via the network communications component, the monetary total for the selected etailer and the respective one or more monetary totals computed for the one or more other etailers, with a facility to switch etailers;
sending, by the one or more computers via the network communications component, an electronic communication to one of the etailers to deliver the one or more products and/or services to the first customer, upon receiving a purchase request for the one etailer; and
initiating transfer, by the one or more computers, of funds to the one etailer when the purchase request has been received.

11. The method as defined in claim 10, further comprising executing a respective contract with each of the plurality of etailers to withhold and not disclose customer identification data to the company issuer of the electronic coupon that was applied.

12. The method as defined in claim 10,
wherein there are a plurality of products and/or services selected in the online shopping cart, and
wherein the computing steps for the monetary totals for the selected etailer and the one or more other etailers, comprises adding respective prices for the respective products and/or services to obtain the monetary total for the respective etailer.

13. The method as defined in claim 10,
serving, by one or more computers, upon initiation of a loyalty card association process, a list of a plurality of loyalty cards of retailers to a second one of the customer devices;
receiving, by the one or more computers via the network communications component, a selection of one of the plurality of the loyalty cards from the second customer device;
receiving, by the system communications component, a captured image or scan of a coupon for a product or service from the second customer device;
identifying the image or scan of the coupon and accessing, by the one or more computers, data associated with a company issuer of the coupon for creating an electronic coupon;
creating, by the one or more computers, an electronic coupon for the product or service based at least in part on the data for the electronic coupon; and
electronically associating in memory, by the one or more computers, upon receipt of the selection of the loyalty card of one of the retailers, the electronic coupon to the loyalty card of the second customer for the selected retailer.

14. A method, for operating a customer network device of a customer that comprises:
a communications component configured to communicate electronically over one or more networks;
an image capture or scanner component;
a graphical user interface (GUI) screen;
a memory configured with one or more API's for access to a first server and a second server;
a computer processor operatively connected to the image capture or scanner component, the GUI screen, and the memory,
wherein the method comprises:
a loyalty card association sub-method comprising:
receiving, by the computer processor via the network communications component, a first list of a first plurality of retailers, and displaying, by a computer on a screen, the first list of the first plurality of retailers;
receiving, by the computer processor via the network communications component, a selection of one of the retailers from the customer;
imaging or scanning, by the image capture or scanner component, a coupon of a company issuer for a product or service to obtain a first coupon image or scan;
transmitting, by the communications component, the first coupon captured image or scan to the first server with instructions to create a first electronic coupon and associate it to a loyalty card of the retailer selected;
an online shopping cart sub-method, comprising:
receiving, by the computer processor via the network communications component, a second list of a second plurality of etailers, for the online shopping sub-method;
receiving a selection of one of the etailers from the second list from the customer;
transmitting, by the network communications component, the selected etailer from the second list to the second server;
obtaining, by the image capture or scanner component, a second coupon captured image or scan of a second coupon for a product or service;
transmitting, by the communications component, the second coupon captured image or scan to the second server to create a second electronic coupon;
receiving, via the communications component and displaying on the GUI screen, data for the product and/or service associated with the second coupon along with the respective price with a discount of the second electronic coupon applied, and receiving data for other products and/or services offered by the selected etailer from the second list;
receiving, by the computer, a selection of one or more products and/or services from the customer for an online shopping cart process for the selected etailer of the second list;
receiving, by the computer processor via the communications component, a monetary total for the selected etailer of the second list for the one or more products and/or services selected in the online shopping cart sub-method and automatically apply the discount for the second coupon;
receiving, by the computer processor via the communications components and displaying on the GUI, a list of one or more other of the etailers that sell the one or more products or services listed in the shopping cart, with a respective monetary total for each of the one or more other of etailers for the one or more of the products and/or services in the online shopping cart with the discount for the second electronic coupon applied, with a switching button or other indicator to switch etailers;
switching, by the computer processor, to one of the one or more other etailers, when the switching button or other indicator is activated;
displaying on the GUI screen, by the computer processor, the one or more products and/or services in the cart, when a viewing button or other indicator is activated;
cancelling, by the computer processor, the online shopping process when a cancellation button or other indicator is activated; and
sending, by the computer processor, an electronic communication to deliver the one or more products and/or services from one of the etailers to the customer and to transfer funds to the one etailer, when a purchase button or other indicator is activated.

15. A customer electronic communication device, comprising:
a communications component configured to communicate electronically over one or more networks;
an image capture or scanner component;
a graphical user interface (GUI) screen;
a processor operatively connected to the image capture or scanner component, the GUI screen, and the memory,
wherein the processor is configured with processes:
an association process that uses the image capture or scanner component to image capture or scan a first coupon of a company issuer and facilitate association of the coupon with a selected loyalty card;
an online shopping cart process using the image capture or scanner component to image capture or scan a second coupon and initiate online shopping via the Internet by the communications component;
wherein the association process to image capture or scan and associate the coupon to a loyalty card comprises sub-processes and menus for display on the GUI screen to:
display, by the processor on the GUI screen, loyalty cards of multiple retailers and a capability to receive a selection of a loyalty card of one of the retailers from a customer;
activate, by the processor, the image capture or scanner component to image capture or scan a coupon for a product or service;
transmit, by the communications component, the coupon image capture or scan to a server to create an electronic coupon and associate it to a loyalty card of the one retailer selected; and
wherein the online shopping cart process of comprises sub-processes and menus for display on the GUI screen to
display, by the processor on the GUI screen, multiple etailers and receive a selection of one of the etailers from the customer;
activate, by the processor, the image capture or scanner component to image capture or scan a coupon for a product or service;
transmit, by the communications component, the coupon captured image or scan of the coupon to the second server for creation of an electronic coupon;
access via the communications component and display on the GUI screen data for the product and/or service to which the coupon applies and other products and/or service offered by the selected etailer, and receive a selection of one or more of the products and/or services from the customer for an online shopping cart;
receive, via the communications component and display on the screen: 1) a monetary total for the selected etailer for the one or more products and/or services selected in the online shopping cart with the electronic coupon automatically applied where applicable; and 2) a respective monetary total for each of one or more other of the etailers for the one or more products and/or services selected in the online shopping cart process with the electronic coupon automatically applied in computing the respective one or more monetary totals;
generate, by the processor, a display on the screen with:
a button or other indicator to switch to one of the one or more other etailers;
with a button or other indicator to cancel one or more products or services from the online shopping cart process,
with a button or other indicator to send an electronic communication to purchase and have delivered the one or more products and/or services from one of the etailers to the customer; and
a process configured in the processor to initiate transfer of funds to the one etailer upon the button or other indicator being activated to purchase.

16. A method, comprising:
receiving by an etailer when an online shopping cart process is initiated, by the one or more computers via the network communications component, a coupon captured image or scan for a product or service;
identifying the image or scan, by the one or more computers;
determining, by the one or more computers, a company issuer of the coupon;
accessing, by the one or more computers, data associated with the company issuer for electronic coupon creation;
identifying, by the one or more computers, the product and/or service to which the coupon applies that is offered by the retailer;
creating, by the one or more computers, an electronic coupon for the product or service based at least in part on the data for the electronic coupon;
feeding, by the one or more computers via the network communications component, data on the products and/or services of the etailer associated with the coupon, including data on a price of the product and/or service with the electronic coupon applied, and feeding data on other products and/or services of the etailer to the customer device;
receiving, by the one or more computers via the network communications component, a selection of one or more of the products and/or services of the etailer for an online shopping cart in an online shopping cart process;
automatically computing, by the one or more computers, a monetary total for the etailer for the one or more products and/or services selected in the online shopping cart process including automatically applying a discount for the coupon;
serving for display, by the one or more computers via the network communications component, the monetary total for the etailer;
initiating, by the one or more computers via the network communications component, upon receiving a purchase request, a process to deliver the one or more products and/or services to the customer;
initiating transfer of funds to the etailer upon receiving the purchase request;
receiving, by the system communications component upon initiation of a loyalty card association process to a loyalty card of the etailer, a captured image or scan of a coupon for a product or service from the second customer device;
identifying the image or scan of the coupon and accessing, by the one or more computers, data associated with a company issuer of the coupon for creating an electronic coupon;
creating, by the one or more computers, an electronic coupon for the product or service based at least in part on the data for the electronic coupon; and
electronically associating in memory, by the one or more computers, the electronic coupon to the loyalty card of the second customer for the retailer.
